(19) United States
(12) Patent Application Publication
(10) Pub. No.: US 2007/0136118 A1
(43) Pub. Date: Jun. 14, 2007

(54) Method and apparatus for customer scheduling to reduce wait times and increase throughput

(76) Inventors: Brett C. Gerlach, Duvall, WA (US); Brian W. Perrin, Duvall, WA (US)

Correspondence Address: Robert M. Storwick, P.O. Box 386, Mercer Island, WA, 98040, US

(21) Appl. No.: 11/298,161

(22) Filed: Dec. 9, 2005

(51) Int. Cl. G06F 9/46

(52) U.S. Cl. 705/8

(57) ABSTRACT

A time and motion study is conducted to gather timings and factors for each portion of customer visits in an organization. This study draws data from existing management systems as well as special-purpose software built to collect additional data not available in current systems. Multiple regression is then used to analyze these data and determine which factors predict visit lengths, and to develop a model for predicting appointment lengths. This model is then used to assign appointments to different groups with different average lengths. These groups are then arranged in schedule templates and simulated using Monte Carlo simulation techniques. A schedule template is developed, tested and refined by repeated simulation. Finally, once a schedule template has been finalized, it is used to guide the scheduling of appointments, using a program which assigns appointments to one of the groups named by the schedule template, based on factors available at scheduling time.

### TECHNICAL FIELD

The present invention relates to methods and apparatus for scheduling, and more particularly, to methods and apparatus for customer scheduling to reduce wait times and increase throughput.

### BACKGROUND OF THE INVENTION

Most people have experienced the frustration of waiting a long time during a visit to a doctor or some other service-providing organization. Long wait times are a serious problem causing lost wages for customers, introducing frustration and anger into the service environment, bringing significant stress and lengthening workdays for the staff, and causing lost business when customers choose to seek another provider after a lengthy wait.

Scheduled appointments have long been used to reduce wait times and provide staff with a more consistent workday. The effectiveness of scheduling is clear when compared to settings where similar services are provided without appointments, such as in a hospital emergency room.

Unfortunately, although scheduling appointments greatly reduces wait times, it does not entirely eliminate patient and staff waits. Queuing theory identifies variability in inter-arrival times and processing times as principal causes of wait times. (see “Matching Supply with Demand,” by Cachon and Terwiesch, McGraw Hill, 2003, Chapter 7, for a good description of queuing theory as it relates here. The disclosure of this chapter is hereby incorporated by reference.) When customers arrive early or in groups, they wait longer to be seen. When they arrive late or at longer intervals, staff may wait for customers. Likewise, when visits last longer than expected, subsequent customers wait to be seen, and when they finish early, unless there are other customers already waiting, the staff must wait until another customer is ready. Queuing theory also provides equations that predict average wait times for steady-state queues.

One practice that has become popular in medical practices is modified wave scheduling, which involves overbooking certain appointments at regular intervals in order to reduce the impact of variability in arrival times. The basic idea is that if two patients are asked to come at 10:00 AM, and one is a little late, and one is a little early, the late one may have to wait while the early one is seen. This practice increases staff utilization at the expense of patient wait times. (see “Tuning Up Your Patient Schedule,” by M. Kyu Chung, American Academy of Family Physicians News & Publications, http://www.aafp.org/fpm/20020100/41tuni.html. The disclosure of this article is hereby incorporated by reference.)

Another practice that has become common is the use of allocated time. Allocated time consists of reserved appointment slots for specific purposes. For instance, a doctor's office might want to reserve a certain number of slots for walk-ins or elective surgery consults. This allows practices to provide same-day appointments for certain types of appointments, to group related visits (such as surgeries) to take advantage of set-up or travel time, and otherwise to block out time for specific uses.

Most medical practices now use software for scheduling. Scheduling software is often part of a practice management suite, which integrates scheduling, billing, patient insurance information, and sometimes medical records and other services. Electronic scheduling allows for more rapid searching for available appointments, and allows multiple schedulers and providers to share and work with a single schedule while scheduling and serving patients.

Some current software scheduling packages include a feature called templates, which allows a schedule for a particular provider to be laid out as a sequence of appointment slots, including allocated time for specific uses. These templates usually support searching for the next available appointment of a given type.

Although practice management systems make the process of searching for and making appointments easy, they do little to help determine the length and spacing of appointments appropriate for a given provider. Although some offices will time a sample of visits, then use average appointment lengths to set appointment durations and spacing, current scheduling methods rely mostly on human estimates of visit lengths.

Often, practices will use several different appointment lengths (short, medium and long), to allow extra time for new patients or other factors believed to cause longer visits, such as complex procedures. Human judgment is the primary tool used to determine which appointment types or factors map to these various appointment lengths.

Another approach sometimes taken in hospital emergency rooms and large clinics is to model offices or practices using simulation to determine staffing and required equipment and facility levels based on measurements of customer demand and average visit lengths. (See “Improving Outpatient Clinic Staffing and Scheduling with Computer Simulation”, by Fred Hashimoto and Stoughton Bell, Journal of General Internal Medicine 11(3) p. 182-4 1996. The disclosure of this article is hereby incorporated by reference.)

### SUMMARY OF THE INVENTION

A first principal object of the present invention is to increase customer throughput, allowing more customers to be seen given staff and resource constraints.

A second principal object is to control or reduce customer wait times.

Another object is to provide a more predictable workday, by reducing the variability of start and finish times for staff.

Another object is to minimize the impact on existing scheduling practices, by providing an easy-to-learn solution that requires minimal time during customer scheduling, and minimal changes to existing practices.

Another object is to minimize the effort and time required from staff during data collection and deployment.

Another object is to identify bottlenecks in the service process, in order to balance staff or evaluate potential investments in equipment and facilities.

Another object is to understand and make tradeoffs among wait times, customer throughput, staffing levels and workday lengths.

Another object is to measure productivity differences between staff members, properly accounting for differences in duties.

Another object is to measure utilization of various resources and staff.

Another object is to quantify the cost of serving various customer types and providing various services.

The invention begins with the enumeration of factors believed to influence visit durations. Once a set of factors for a statistical model are chosen, a time and motion study of customer visits is performed. Data are drawn from existing management systems where possible, and timings are collected for a sample of visits of various types, along with the factors believed to predict visit durations.

After data are collected, these data are cleaned and analyzed in order to build a statistical model that predicts visit durations. This model is then used to divide appointments into groups, based on visit length. These groups are then arranged in a schedule plan, called a schedule template, which is tested and refined using Monte Carlo simulation.

Once a number of templates are developed and refined, representing various options that make different tradeoffs, the service organization can choose a schedule to implement.

Once a schedule template is selected, a simple program is used during scheduling that assigns each appointment to an appointment group based on its predicted length. This is then matched to the schedule template in order to search for an available appointment.

By combining a time and motion study with a predictive statistical model to segment appointment types, appointment lengths are matched more closely and consistently to required times than they have been using human judgment.

According to a first aspect, the invention is a method for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments is input into the management system by one or more of its staff members. The key resources include staff rooms and equipment.

The method includes the steps of: (a) measuring the lengths of time required from staff members and key resources by a statistically significant sample of appointments; and (b) developing one or more schedule templates that designate how appointments should be scheduled, using a single appointment type for each staff member being scheduled. The method further includes the steps of: (c) testing and refining the one or more schedule templates using Monte Carlo simulation and the measured lengths of time; (d) selecting one of the one or more schedule templates for use in scheduling appointments for the first subject organization; and (e) scheduling appointments according to the selected schedule template.

According to a second aspect, the invention is a method for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments is input into the management system by one or more of its staff members. The key resources include staff rooms and equipment.

The method includes the step of (a) developing a weighted statistical model for a typical organization having staff members and key resources with a typical set of appointments, the weighted statistical model describing the factors expected to predict the length of time that a given appointment requires from the staff members of the typical organization and from the key resources.

The method further includes the step of (b) collecting data for the first subject organization to eliminate factors that do not provide significant predictive power, and to determine the weights of the weighted statistical model that are required to accurately predict the length of time required from staff members for a given appointment based on the factors described by the weighted statistical model.

The method still further includes the steps of (c) adjusting the weights of the weighted statistical model in accordance with the data collected in step (b); and (d) segregating appointments into distinct appointment groups based on predicted time spent with staff members and/or one or more key resources,

Also, the method includes the steps of (e) developing one or more schedule templates that designate how appointments from the distinct appointment groups should be scheduled and combined in order to increase throughput; and (f) testing and refining the schedule templates using Monte Carlo simulation.

Further, the method includes the steps of (g) collecting appointment data from at least one staff member who inputs prospective appointments into the management system for the first subject organization, or from the management system; and (h) designating the distinct appointment group each new appointment belongs to as it is scheduled, using the weighted statistical model so that it can be matched to a schedule template and scheduled at an appropriate time.

According to a third aspect, the invention is a method for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The method includes the step of (a) developing a weighted statistical model for a typical organization having staff members and key resources with a typical set of appointments, the weighted statistical model describing the factors expected to predict the length of time that a given appointment requires from the staff members of the typical organization and from the key resources.

The method further comprises the step of (b) collecting data for the first subject organization to eliminate factors that do not provide significant predictive power, and to determine the weights of the weighted statistical model that are required to accurately predict the length of time required from staff members for a given appointment based on the factors described by the weighted statistical model.

Still further, the method includes the steps of (c) adjusting the weights of the weighted statistical model in accordance with the data collected in step (b); and (d) applying cluster analysis to segregate appointments into distinct appointment groups based on predicted time spent with staff members and/or one or more key resources.

In addition, the method includes the steps of (e) developing one or more schedule templates that designate how appointments from the distinct appointment groups should be scheduled and combined in order to increase throughput; and (f) testing and refining the schedule templates using Monte Carlo simulation.

Yet further, the method includes the steps of (g) collecting appointment data from at least one staff member who inputs prospective appointments into the management system for the first subject organization, or from the management system; and (h) designating the distinct appointment group each new appointment belongs to as it is scheduled, using the weighted statistical model so that it can be matched to a schedule template and scheduled at an appropriate time.

According to fourth aspect, the invention is a method for predicting wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The method includes the steps of (a) segregating appointments into distinct appointment groups based on existing appointment types; (b) collecting timing data for the first subject organization for each appointment group; and (c) describing existing scheduling practices in the form of a schedule template which utilizes the distinct appointment groups.

The method also includes the step of (d) using Monte Carlo simulation and the timing data collected for each of the distinct appointment groups to predict customer wait times for current scheduling policies and practices.

According to a fifth aspect, the invention is a method for creating earlier and more reliable start times in a working period for staff members of an organization having one or more staff members who use a schedule of appointments for its customers, and a service pipeline involving more than one process step, such that at least one staff member must wait on preparatory steps before seeing a customer, the method comprising the steps of:

(a) minimizing the duration of the preparatory steps during an initial portion of the working period by identifying those appointments which require shorter preparatory times and scheduling the appointments with shorter preparatory times in the initial portion of the working period.

According to a sixth aspect, the invention is a method for creating earlier and more reliable finish times in a working period for staff members of an organization having one or more staff members who use a schedule of appointments for its customers, and a service pipeline involving more than one process step, such that at least one staff member must wait on preparatory steps before seeing a customer, the method including the steps of:

(a) minimizing the duration of the preparatory steps during a final portion of the working period by identifying those appointments which require shorter preparatory times and scheduling the appointments with shorter preparatory times in the final portion of the working period.

According to a seventh aspect, the invention is a method for increasing throughput and controlling appointment wait times for customers of a professional office having staff members and key resources subject to policies of the professional office, the professional office having one or more staff members who use a management system that produces customer and schedule data that allows its staff members to manage the operation of the professional office based on prospective appointments for its customers, the prospective appointments being input into the management system by the one or more of its staff members, the key resources including staff rooms and professional equipment, the method including the steps of:

(a) measuring the lengths of time required from staff members and key resources by a statistically significant sample of appointments;

(b) developing one or more schedule templates that designate how appointments should be scheduled, using a single appointment type for each staff member being scheduled;

(c) testing and refining the one or more schedule templates using Monte Carlo simulation and the measured lengths of time;

(d) selecting one of the one or more schedule templates for use in scheduling appointments for the professional office; and

(e) scheduling appointments according to the selected schedule template.

According to an eighth aspect, the invention is an apparatus for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The apparatus includes a computer programmed to measure the lengths of time required from staff members and key resources by a statistically significant sample of appointments; a computer programmed to develop one or more schedule templates that designate how appointments should be scheduled, using a single appointment type for each staff member being scheduled; and a computer programmed to test and refine the one or more schedule templates using Monte Carlo simulation and the measured lengths of time.

The apparatus also includes a computer programmed to select one of the one or more schedule templates for use in scheduling appointments for the first subject organization; and

a computer programmed to schedule appointments according to the selected schedule template.

According to a ninth aspect, the invention is an apparatus for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The apparatus includes a computer programmed to develop a weighted statistical model for a typical organization having staff members and key resources with a typical set of appointments. The weighted statistical model describes the factors expected to predict the length of time that a given appointment requires from the staff members of the typical organization and from the key resources.

The computer is programmed to collect data for the first subject organization to eliminate factors that do not provide significant predictive power, and to determine the weights of the weighted statistical model that are required to accurately predict the length of time required from staff members for a given appointment based on the factors described by the weighted statistical model.

The apparatus also includes a computer programmed to adjust the weights of the weighted statistical model in accordance with the data collected by the computer programmed to collect data for the first subject organization to eliminate factors that do not provide significant predictive power.

The apparatus also includes a computer programmed to segregate appointments into distinct appointment groups based on predicted time spent with staff members and/or one or more key resources and a computer programmed to develop one or more schedule templates that designate how appointments from the distinct appointment groups should be scheduled and combined in order to increase throughput.

The invention further includes a computer programmed to test and refine the schedule templates using Monte Carlo simulation; and a computer programmed to collect appointment data from at least one staff member who inputs prospective appointments into the management system for the first subject organization, or from the management system.

The apparatus includes a computer programmed to designate the distinct appointment group each new appointment belongs to as it is scheduled, using the weighted statistical model so that it can be matched to a schedule template and scheduled at an appropriate time.

According to a tenth aspect, the invention is an apparatus for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members, the key resources including staff rooms and equipment.

The apparatus includes a computer programmed to develop a weighted statistical model for a typical organization having staff members and key resources with a typical set of appointments. The weighted statistical model describes the factors expected to predict the length of time that a given appointment requires from the staff members of the typical organization and from the key resources.

The apparatus also includes a computer programmed to collect data for the first subject organization to eliminate factors that do not provide significant predictive power, and to determine the weights of the weighted statistical model that are required to accurately predict the length of time required from staff members for a given appointment based on the factors described by the weighted statistical model.

The apparatus further includes a computer programmed to adjust the weights of the weighted statistical model in accordance with the data collected by the computer programmed to collect data; a computer programmed to apply cluster analysis to segregate appointments into distinct appointment groups based on predicted time spent with staff members and/or one or more key resources; a computer programmed to develop one or more schedule templates that designate how appointments from the distinct appointment groups should be scheduled and combined in order to increase throughput;

a computer programmed to test and refine the schedule templates using Monte Carlo simulation;

a computer programmed to collect appointment data from at least one staff member who inputs prospective appointments into the management system for the first subject organization, or from the management system; and

a computer programmed to designate the distinct appointment group each new appointment belongs to as it is scheduled, using the weighted statistical model so that it can be matched to a schedule template and scheduled at an appropriate time.

According to an eleventh aspect, the invention is an apparatus for predicting wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus including:

a computer programmed to segregate appointments into distinct appointment groups based on existing appointment types;

a computer programmed to collect timing data for the first subject organization for each appointment group;

a computer programmed to describe existing scheduling practices in the form of a schedule template which utilizes the distinct appointment groups;

a computer programmed to use Monte Carlo simulation and the timing data collected for each of the distinct appointment groups to predict customer wait times for current scheduling policies and practices.

According to a twelfth aspect, the invention is an apparatus for creating earlier and more reliable start times in a working period for staff members of an organization having one or more staff members who use a schedule of appointments for its customers, and a service pipeline involving more than one process step, such that at least one staff member must wait on preparatory steps before seeing a customer, the apparatus including:

a computer programmed to minimize the duration of the preparatory steps during an initial portion of the working period by identifying those appointments which require shorter preparatory times and scheduling the appointments with shorter preparatory times in the initial portion of the working period.

According to a thirteenth aspect, the invention is an apparatus for creating earlier and more reliable finish times in a working period for staff members of an organization. The organization has one or more staff members who use a schedule of appointments for its customers and a service pipeline involving more than one process step, such that at least one staff member must wait on preparatory steps before seeing a customer.

The apparatus includes a computer programmed to minimize the duration of the preparatory steps during a final portion of the working period by identifying those appointments which require shorter preparatory times and scheduling the appointments with shorter preparatory times in the final portion of the working period.

According to an fourteenth aspect, the invention is an apparatus for increasing throughput and controlling appointment wait times for customers of a professional office having staff members and key resources subject to policies of the professional office. The professional office has one or more staff members who use a management system that produces customer and schedule data that allows its staff members to manage the operation of the professional office based on prospective appointments for its customers. The prospective appointments are input into the management system by the one or more of its staff members. The key resources include staff rooms and professional equipment.

The apparatus includes a computer programmed to measure the lengths of time required from staff members and key resources by a statistically significant sample of appointments; a computer programmed to develop one or more schedule templates that designate how appointments should be scheduled, using a single appointment type for each staff member being scheduled; and a computer programmed to test and refine the one or more schedule templates using Monte Carlo simulation and the measured lengths of time.

The apparatus further includes a computer programmed to select one of the one or more schedule templates for use in scheduling appointments for the professional office; and a computer programmed to schedule appointments according to the selected schedule template.

According to a fifteenth aspect, the invention is an apparatus for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The apparatus includes means for measuring the lengths of time required from staff members and key resources by a statistically significant sample of appointments, means for developing one or more schedule templates that designate how appointments should be scheduled, using a single appointment type for each staff member being scheduled, and means for testing and refining the one or more schedule templates using Monte Carlo simulation and the measured lengths of time.

The apparatus further includes means for selecting one of the one or more schedule templates for use in scheduling appointments for the first subject organization, and means for scheduling appointments according to the selected schedule template.

According to a sixteenth aspect, the invention is an apparatus for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The apparatus includes means for developing a weighted statistical model for a typical organization having staff members and key resources with a typical set of appointments. The weighted statistical model describes the factors expected to predict the length of time that a given appointment requires from the staff members of the typical organization and from the key resources. The apparatus also includes means for collecting data for the first subject organization to eliminate factors that do not provide significant predictive power and for determining the weights of the weighted statistical model that are required to accurately predict the length of time required from staff members for a given appointment based on the factors described by the weighted statistical model.

The apparatus also includes means for adjusting the weights of the weighted statistical model in accordance with the data collected by the computer programmed to collect data for the first subject organization to eliminate factors that do not provide significant predictive power, and means for segregating appointments into distinct appointment groups based on predicted time spent with staff members and/or one or more key resources.

The apparatus also includes means for developing one or more schedule templates that designate how appointments from the distinct appointment groups should be scheduled and combined in order to increase throughput, and means for testing and refining the schedule templates using Monte Carlo simulation.

The apparatus further includes means for collecting appointment data from at least one staff member who inputs prospective appointments into the management system for the first subject organization, or from the management system, and means for designating the distinct appointment group each new appointment belongs to as it is scheduled, using the weighted statistical model so that it can be matched to a schedule template and scheduled at an appropriate time.

According to a seventeenth aspect, the invention is an apparatus for increasing throughput and controlling appointment wait times for customers of a first subject organization having staff members and key resources subject to policies of the first subject organization. The first subject organization has one or more staff members who use a management system that produces customer and schedule data that allows its staff members to manage the operation of the first subject organization based on prospective appointments for its customers. The prospective appointments are input into the management system by the one or more of its staff members. The key resources include staff rooms and equipment.

The apparatus includes means for developing a weighted statistical model for a typical organization having staff members and key resources with a typical set of appointments, the weighted statistical model describing the factors expected to predict the length of time that a given appointment requires from the staff members of the typical organization and from the key resources.

The apparatus also includes means for collecting data for the first subject organization to eliminate factors that do not provide significant predictive power, and for determining the weights of the weighted statistical model that are required to accurately predict the length of time required from staff members for a given appointment based on the factors described by the weighted statistical model.

The apparatus further includes means for adjusting the weights of the weighted statistical model in accordance with the data collected by the computer programmed to collect data, and means for applying cluster analysis to segregate appointments into distinct appointment groups based on predicted time spent with staff members and/or one or more key resources.

In addition, the apparatus includes means for developing one or more schedule templates that designate how appointments from the distinct appointment groups should be scheduled and combined in order to increase throughput, and means for testing and refining the schedule templates using Monte Carlo simulation.

Further, the apparatus includes means for collecting appointment data from at least one staff member who inputs prospective appointments into the management system for the first subject organization, or from the management system, and means for designating the distinct appointment group each new appointment belongs to as it is scheduled, using the weighted statistical model so that it can be matched to a schedule template and scheduled at an appropriate time.

### BRIEF DESCRIPTION OF THE DRAWINGS

FIG. 1 is a block diagram of the system for data collection and model building.

FIG. 2 shows an exemplary user interface that is displayed by a program for data collection used at the location where patients check in.

FIG. 3A shows a first exemplary screen that is displayed by a program for data collection used in the examination rooms.

FIG. 3B shows a second exemplary screen that is displayed by a program for data collection used in the examination rooms.

FIG. 4A shows a histogram and normal quantile plot of doctor minutes timings.

FIG. 4B shows a histogram and a normal quantile plot of doctor log-minutes after a natural log transform of doctor minute timings.

FIG. 4C shows the output from a statistical analysis package after running a multiple regression analysis on the doctor log-minutes data.

FIG. 4D shows a histogram and normal quantile plot of preparation time.

FIG. 4E shows the output from a statistical analysis package after running a multiple regression analysis on the preparation time data.

FIG. 4F is a portion of the output from k-means cluster analysis, run on predicted preparation minutes.

FIG. 4G is a portion of the output from k-means cluster analysis, run on predicted doctor minutes.

FIG. 5 shows an exemplary schedule template.

FIG. 6 shows portions of an exemplary table of actual timings and group assignments.

FIG. 7 is a user interface used to define resource levels required by the simulator program.

FIG. 8 is an exemplary output table produced by the simulator program, showing 90th percentile wait times for each event during each appointment.

FIG. 9 is an exemplary graph of the wait time data produced by the simulator.

FIG. 10 is an exemplary chart which compares key metrics and wait times produced by the simulator program for a baseline appointment template and for a first option appointment template.

FIG. 11A is a schematic diagram showing the result of simulating a medical practice at a first time using Monte Carlo simulation.

FIG. 11B is a schematic diagram showing the result of simulating a medical practice at a later time than that shown in FIG. 11A, using Monte Carlo simulation.

FIG. 11C is a schematic diagram showing the result of simulating a medical practice at a later time than that shown in FIG. 11B, using Monte Carlo simulation.

FIG. 12 is a flow diagram for the steps of scheduling the appointment using the present invention.

FIG. 13 is an exemplary appointment template for one doctor, ready to be used to guide actual appointment scheduling.

FIG. 14 shows an exemplary user interface displayed by a program used by the scheduler to assign each new appointment to the appropriate group for scheduling.

### DETAILED DESCRIPTION OF THE PREFERRED EMBODIMENT OF THE INVENTION

The following detailed description will be made in the context of the broad steps of a method. It will be understood that the steps of the method described can be accomplished by means of a conventional computer system, including a display device. The broad steps are: Gather Data, Create a Baseline, Build the Weighted Statistical Model, Develop Appointment Groups, Develop a Schedule Template, Test the Template, Refine the Template, and Schedule the Appointments.

Gather Data.

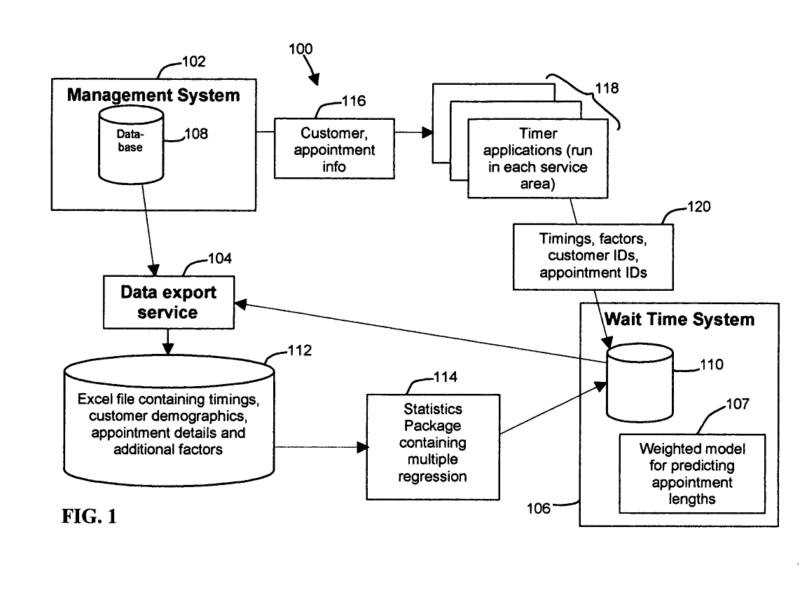

FIG. 1 is a block diagram of the system for data collection and model building. The system 100 includes a management system 102, a data export service 104, and a wait time system 106. The wait time system 106 includes a weighted statistical model 107 for predicting appointment lengths. Respective databases 108 and 110 in the management system 102 and the wait time system 106 are made available to the data export service 104. The data export service 104 produces a file 112 (such as an Excel file) that contains timings, customer demographics, appointment details and additional factors. The file 112 is passed to a statistics package 114 which includes multiple regression. The output of the statistics package 114 is passed to the wait time system 106.

The management system 102 also produces customer and appointment information 116 which is communicated to timer applications 118 (to be described below) that run in each service area of the organization. These timer applications produce data 120, including timings, factors, customer identifications, and appointment identifications. These data are then passed to the database 110 in the wait time system.

Through discussion with the staff, factors that are likely to significantly affect appointment lengths are identified. For example, in an eye clinic, the reason for the visit (reason code), the doctor, the presence of a translator, and whether the patient is at the office for the first time might be factors selected for inclusion in the model.

Some of these factors can be collected via software directly from the management system, and others require new user interface code. In the example, the management system can provide data regarding whether a patient is new or not, which doctor the appointment is with, and the reason code for the visit, but the presence of a translator must be collected using a new user interface, since these data are not normally collected by current practice management systems.

To collect the data required, two programs are necessary. First, a patient check-in program must run which collects the list of patients scheduled that day and records their check-in times. These data may be available from the management system, or it may be necessary to collect them from the receptionist. FIG. 2 shows an exemplary user interface that is displayed by a timer program (a timer application 118) for data collection used at the location where patients check in. This program collects the list of patients from the management system and records the time of check-in each time the receptionist selects a patient and clicks OK.

Second, at each point where patients are seen, an exam room monitor program (another timer application 118) runs which presents the list of patients that have checked in and measures the duration of each patient-staff interaction. The program will collect from the management system those factors that are believed to be relevant for predicting appointment durations, and will also record any relevant factors, such as the presence of a translator, using its own user interface. These values, as well as the visit durations, are recorded in the wait time system database.

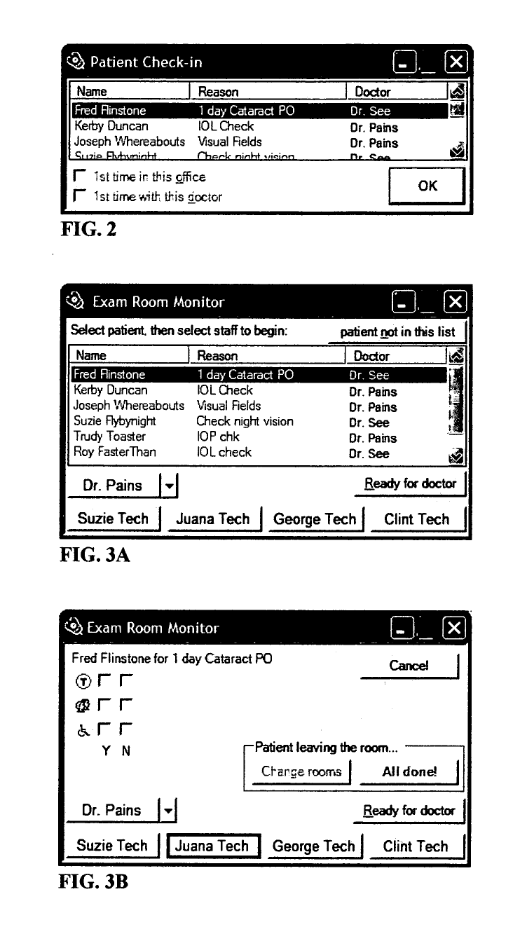

FIG. 3A shows a first exemplary screen that is displayed by a program for data collection (timer applications) used in the examination rooms. The example in FIG. 3A illustrates the first screen of the exam room monitor program, which works as follows:

As each staff member begins a visit, she selects the patient she will see, and then presses the button on the first screen of the exam room monitor program with her name on it, which starts a software timer. As she leaves, she stops it in the same way. When the patient is placed in a room to wait for the doctor, a “Ready for doctor” button in the first screen is used to collect a timestamp for the beginning of the wait for the doctor and the end of the previous portion of the appointment. Other methods of collecting these data could also be used to start and stop the timers for both customers and staff members, including reading barcodes on charts or cards, cardkeys, thumbprint readers, or radio-frequency identification (RFID). All that is necessary is to identify the coming and going of patients and staff so that the exam room monitor program can start and stop its timer appropriately.

FIG. 3B shows a second exemplary user interface that is displayed by a program for data collection used in the examination rooms. Once the timer is started, a second screen of the exam room monitor program presents a set of factors to be collected, in addition to the buttons required to signal the end of the visit, for example, as shown in FIG. 3B. The T in a circle is for talkative patients. The two heads represent the presence of a translator, and the wheelchair represents mobility impairment. This program uses these icons in order to avoid labeling patients in a way that might offend them, were they able to see the screen. Before indicating that the patient is done or ready to move to another room, the program requires the staff to answer whether each of these factors describes this patient.

This program is merely an illustration of one possible design for collecting timings and factors. Any number of other designs could also work. The requirement is that the program collects the data that are selected for inclusion in the model from the management system and from the staff during visits.

After a period of data collection adequate to provide enough data for successful statistical analysis, the data are exported to a format that can be analyzed using a statistical software package. For example, Microsoft® Data Transformation Services could be used to move the data from a SQL Wait Time System database to Microsoft® Excel format. (Microsoft® Data Transformation Services and Microsoft® Excel are from the Microsoft Corporation, of Redmond, Wash.) If the data collection program is written to store its data directly in a format that is readable by a statistics package, then this step can be omitted.

Using Microsoft® Excel or another data editing software package, the data are then reviewed and cleaned as needed. The cleaning step includes looking for data points with zero time, overlapping times that appear to indicate the same staff member was serving multiple patients simultaneously in separate rooms, timings which span the nighttime hours, etc. Each of these indicates misuse of the timing program and identifies data that should be excluded from the final analysis.

The next step is to create a baseline measure of current practices, before developing a new template for scheduling.

Create a Baseline.

In order to determine the impact of new scheduling policies, it is necessary to create a baseline against which new templates can be measured. To create a baseline, a Monte Carlo simulation that matches current practices is built using one of two possible approaches. The first option is to use a math library such as the Intel® Math Library to generate random numbers that roughly match the distributions observed for each important activity, such as patient arrival times, doctor visit lengths, technician visit lengths, etc. The second option is to use actual data. To use actual data, gather a set of actual doctor visit lengths with their associated technician visit lengths and any other important observations required by the Monte Carlo simulation, and then randomly select from this set of timings for each appointment in each trial for the Monte Carlo simulation. The output from the Monte Carlo simulation can then be used for comparison to see if new templates provide improvements to current practices.

The simulation should be instrumented to provide a few key metrics for analysis, such as:
Average wait times per appointment provides an overall measure of expected waits.
90th and 99th percentile wait times per appointment provide a sense for wait times on a bad day.
10th and 90th percentile doctor start and finish times give a sense for how predictably the day begins and ends for the doctor, and how early or late he starts and finishes seeing patients.
The number of appointment slots provides a measure of the capacity each schedule template offers.
Revenue (the number of appointments multiplied by average billings per appointment) provides a measure of the economic value of each schedule template. Because costs are mostly fixed in most medical practices, differences in revenue approximate differences in profit between alternative schedule templates.

These key metrics can be graphed to make meaningful comparisons between the baseline and schedule templates (developed below). As each schedule template is developed and simulated, its impact on patient throughput, wait times and staff workday length can be evaluated in order to choose the best schedule template to use for scheduling.

Build the Weighted Statistical Model.

By applying standard multiple regression analysis techniques to the timing data and factors collected during data collection, factors are included or excluded based on statistical significance until a concise model is developed which predicts the length of each patient-staff interaction. Note that each staff member may require a different model. The important thing is to study the results of the regression analysis in order to determine which factors provide the most statistical power for predicting appointment lengths for each staff member. Because scheduling takes longer if more factors are included in the model, the added power of each additional factor should be weighed against the cost of collecting it at scheduling time.

Consider the following example to illustrate how multiple regression can be used to develop the weighted statistical model from the data that has been collected. Assume that the following factors were collected, based on the assumption that these may impact visit lengths:
Doctor performing the exam
Reason code for the visit
The tests to be performed
The age of the patient
Whether the patient is new
Presence of a translator

In addition, timings for many visits have been collected, measuring the time spent with the doctor as one value, and with the technician as another value.

The goal is to predict two things: first, the visit length with the doctor, because he is assumed to be the limiting resource, or the bottleneck. Second, the preparation time required from the time the patient checks in until the patient is ready to see the doctor. Because the timing data does not include total preparation time, it will have to be calculated. Preparation time includes all of the technician time, plus any time associated with waiting for the eyes to dilate. An estimate of 15 minutes is used for the dilation time, and added to the technician times that have been collected for each appointment that included dilation, which is one of the factors that have been gathered. This value is called “preparation time.”

The following example uses the SAS JMP® statistical analysis package, by SAS Institute, Inc., of Cary, N.C.. The data have already been cleaned in a previous step.

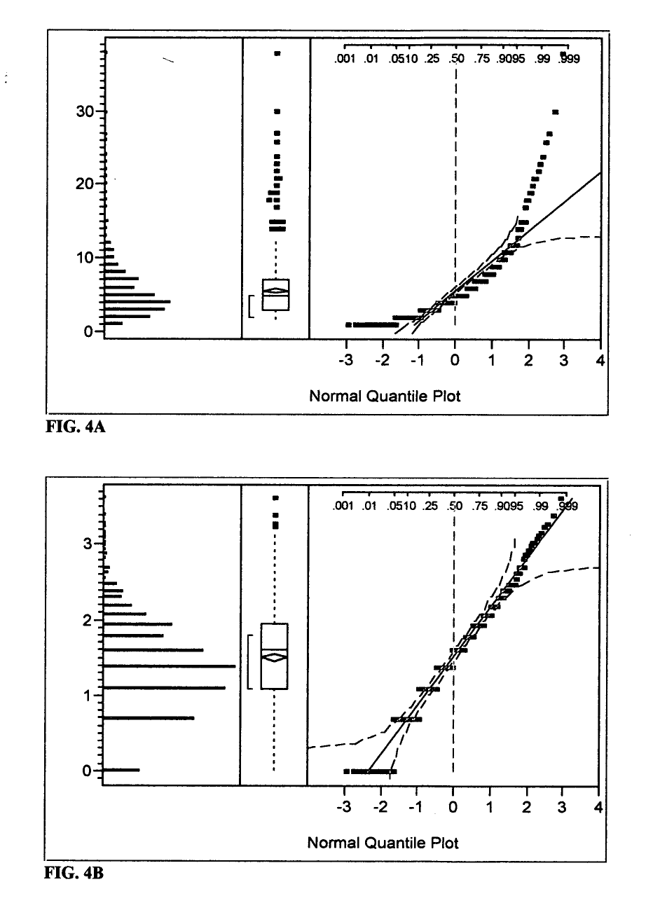

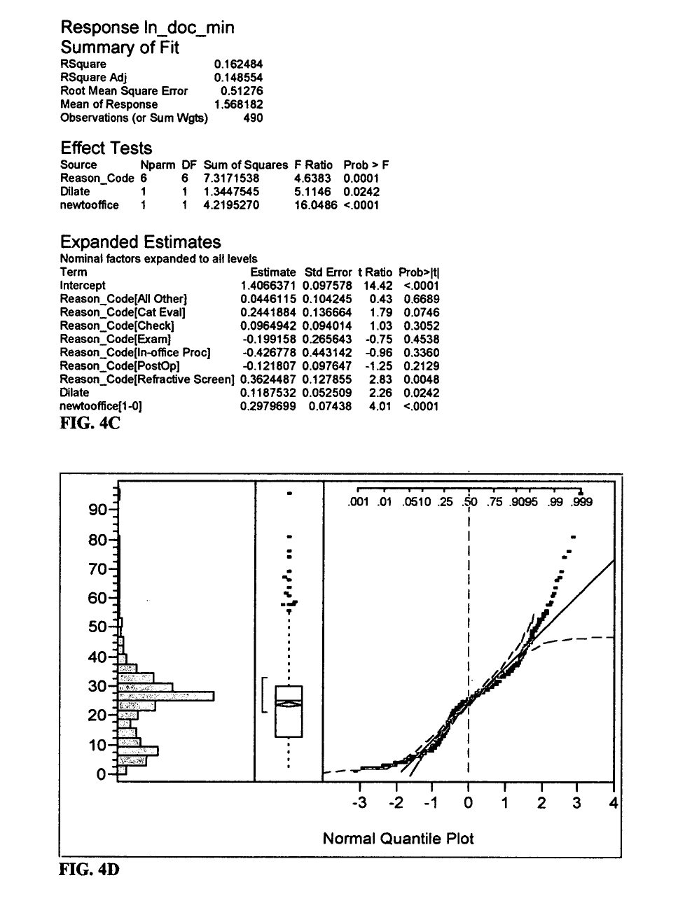

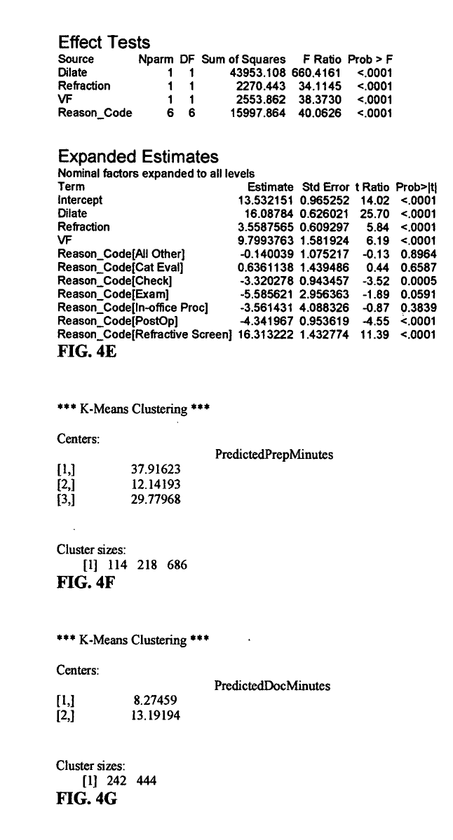

FIG. 4A shows a histogram and normal quantile plot of doctor minutes timings. The normal quantile plot in FIG. 4A, which compares this distribution of values to a normal distribution of values, shows that the doctor visit timings do not follow a normal distribution (if they did, the points would all fall on the diagonal line in the box at the right). The first task is to transform the dependent variable (in this case, doctor minutes) into something that approximates a normal distribution, so that standard least squares regression can use be used more effectively. After trying a number of transforms, it has been found that taking the natural log of doctor minutes yields an approximately normal distribution. This distribution is therefore log-normal. Because of this, transforming these data from minutes to log-minutes will make standard least squares regression more effective at producing reliable predictions of visit lengths. FIG. 4B shows a histogram and a normal quantile plot of doctor log-minutes after a natural log transform of doctor minute timings. The normal quantile plot in FIG. 4B confirms that this distribution is approximately normal.

Next, multiple regression is applied, using the doctor log-minutes as the dependent variable; and doctor, reason code, tests, age and mobility as independent factors. FIG. 4C shows a portion of the output from the statistical analysis package after running a multiple regression analysis on the doctor log-minutes data, after removing factors that were not significant at the 95% confidence level.

The weighted model can now be created, based on this output, as follows:

Using the coefficients from the expanded estimates table, (from the column labeled “Estimate” in FIG. 4C) the following formula (rounding to two decimal places) can be derived:
Doctor log-minutes=Intercept+Reason Code Value+Dilate Value+New to Office Value

Intercept=1.41

Reason Code Value=0.04 if reason was “All Other”, 0.24 for “Cat Eval”, 0.10 for “Check,” and so on

Dilate Value=0.12 if the patient was dilated, 0 otherwise

New to Office Value=0.30 if the patient is new to the office, 0 otherwise

Using the above equation, this model is then added to the spreadsheet containing the timing and factor data, so that a new column called “Predicted Doctor Log-minutes” contains the formula above. To convert the values above to predicted doctor minutes, another column can be added to the timings spreadsheet which raises e (2.71828) to the power of predicted doctor log-minutes. This transforms the natural log values back to base 10 values.

The analysis for preparation time is somewhat different, as shown below.

FIG. 4D shows a histogram and normal quantile plot of preparation time. The histogram in FIG. 4D shows bimodality in the distribution, and some deviation from normality. However, although the distribution isn't perfectly approximated by a normal distribution, it is close enough to get a good result in practice, and better than a log-normal fit. Preparation time values will be used as a dependent variable for multiple regression without transforming it in any way.

FIG. 4E shows the output from the statistical analysis package 114 after running a multiple regression analysis on the preparation time data. This output shows the results of a multiple regression analysis with preparation minutes as the dependent variable, and three tests (dilate, refraction, visual field) plus the reason code as independent variables. As the effect tests indicate, all of these factors are statistically significant predictors of preparation time at the 99.9% confidence level (as indicated by a very small p-value at the far right, which indicates the probability that the effect is an accident of sampling error).

The same output also gives the weights needed to predict preparation time. Because the dependent variable (preparation minutes) was not transformed, the weighted statistical model is simpler:
Preparation Time=Intercept+Dilate Value+Refraction Value+VF Value+Reason Code Value
Intercept=13.53
Dilate Value=16.09 if dilated, 0 if not
Refraction Value=3.56 if refracted, 0 if not
VF Value=9.80 if visual fields measured, 0 if not
Reason Code Value=−0.14 if “All Other”, 0.64 if “Cat Eval”, −3.32 if “Check”, etc.

The result of this equation is the expected preparation time in minutes for a given appointment. As before, a new column is added to the timings data to predict preparation time, filled in with this formula.

Develop Appointment Groups.

The next step is to use the weighted statistical model just developed to distinguish appointments of varying lengths, so that distinct appointment groups can be identified and used for scheduling. To do this, separate the appointments into several appointment groups based on their predicted lengths. There are two objectives to keep in mind here: first, each group must be large enough to be useful. Small groups lead to schedule template slots that are difficult to fill. Second, the groups' average visit lengths should be spread as far apart as possible. The more powerful the statistical model is and the better the choice of group boundaries, the more spread there will be in the groups. Although choosing groups can be done effectively by visual inspection, k-means cluster analysis gives a more consistent result of excellent quality (see “A Tutorial on Clustering Algorithms,” by Matteo Matteucci, http://www.elet.polimi.it/upload/matteucc/Clustering/tutorial html/kmeans.html. The disclosure of this article is hereby incorporated by reference.)

An example will make it clear how cluster analysis is used here. The example below was created using S-Plus 2000®, by Mathsoft Engineering and Education, Inc., of Cambridge, Mass.

First, load the predicted doctor minutes for each doctor separately into the statistics package, then run k-means cluster analysis on these data. Cluster analysis divides these data into groups which are as similar as possible within each group, and as different as possible across groups. More precisely, the between-group variability divided by the within-group variability is maximized. This is precisely the result needed in order to build better schedules.

It must be decided how many clusters will be formed as an input to cluster analysis. Normally, two or three clusters is best. The cluster analysis output will include two important pieces of information: the cluster sizes and centers. If any of the cluster sizes as a proportion of the overall sample are too small, it will be difficult to use them effectively in each template. Cluster sizes that are less than about 5% of the sample are not workable. If a cluster size is too small, try using fewer clusters.

The cluster sizes will be used to determine the proportion of each appointment group in the schedule template. The centers define the center of each group of appointments. The centers are used to assign appointments to specific appointment groups. After predicting the length of the visit, assign each appointment to the group with the nearest center. Repeat this process for predicted preparation time in order to create groups based on preparation time.

FIG. 4F shows a portion of the output of k-means cluster analysis of preparation time. This output indicates that cluster analysis has split the sample into three groups, with centers and sizes as shown in FIG. 4F.

To determine which group each appointment belongs to, first use the appropriate adjusted statistical model to predict preparation minutes. Then, compare the predicted value to each of the cluster centers, and assign the appointment to the closest group. For example, an appointment with a predicted prep time of 15 minutes is 15−12.14=2.86 minutes from group 2, and 29.78−15=14.78 minutes from group 3, and 37.9−15=22.9 minutes from group 1. Because group 2 is closest, this appointment would be assigned to group 2.

Different names will be assigned to each of these groups below for convenience, but these centers will continue to be used to determine which group to assign each appointment to.

FIG. 4F is a portion of the output from k-means cluster analysis, run on predicted preparation minutes. Notice that group 3 in FIG. 4F is the largest group. This group might be segmented further based on predicted doctor minutes, without further dividing the other groups above because of their small size. To do this, the predicted doctor minutes data for only the appointments in group 3 would be loaded and run another cluster analysis, further separating this group into two clusters.

FIG. 4G is a portion of the output from k-means cluster analysis, run on predicted doctor minutes for the group 3 data identified above. This output indicates that further splitting the medium-length preparation time cluster into two new clusters yields one with a central predicted doctor visit of 8.3 minutes, and another with a longer visit of 13.2 minutes. These groups will continue to be used in addition to the initial split by preparation time to describe the appointments based on both preparation time and doctor visit length.

After completing this cluster analysis, there are four groups all together, with the following average characteristics, to which have been assigned meaningful names:
Group PS has short preparation time and varying doctor time
Group PMDS has medium preparation time and short doctor time
Group PMDL has medium preparation time and long doctor time
Group PL has long preparation time and varying doctor time

Group PS is the same group defined by cluster analysis of preparation time above as cluster 2. Group PL is the same as cluster 1. Cluster 3 was split into two new groups by applying cluster analysis to predicted doctor minutes for appointments in this cluster.

There were 114+218+686=1018 data points in the cluster analysis for preparation time. Hence Group PS represents 218/1018=21.4% of the overall sample. Group PL represents 11.2% of the sample. Group PMDS represents 23.8% and PMDL represents 43.6% of the total sample. Assuming the sample is representative of the overall population of appointments, the method will plan to match these group proportions in the schedule template. In other words, in order to provide the right mix of appointment sizes, the template must contain approximately 21.4% PS appointments, 23.8% PMDS, 43.6% PMDL and 11.2% PL appointments.

Develop a Schedule Template.

A schedule template defines appointment slots and indicates which appointment types each slot may be used for. Normally, an uninterrupted block of work time, such as a four hour block that could represent either the time prior to lunch or the time after lunch, is the best unit to use for developing and refining a template. The process of developing a template for scheduling is iterative. A candidate template is devised and tested using Monte Carlo simulation, then modified as needed until wait time goals and staff workday length are met while maximizing the number of appointments in the day. Wait time goals are set by discussion with the staff. For example, a practice may agree that 90th percentile patient wait times should not exceed 20 minutes for any single event, and 99th percentile wait times should not exceed 40 minutes for any single event. Any schedule template that did not meet these standards would be rejected.

There are several goals that must be kept in mind in order to develop a good template:

1. Balance staff. Usually, patients are seen by more than one staff member. For example, in an eye clinic, a technician would see the patient first, run a series of tests, and then hand the patient off to be seen by the doctor. Normally, the pace at which doctors and technicians work is different, so the number of technicians per doctor is important. Too few technicians will force the doctor to sit idle while waiting for patients to be delivered to him. Too many technicians wastes money. The appropriate ratio can be determined the following way:

Divide the average technician minutes per patient by the number of doctor minutes per patient, and round up. This is the minimum number of technicians per doctor required to serve patients when that doctor is working. Note that the number of rooms or amount of equipment available may force a smaller number to be used, in which case, technicians will be the limiting factor which determines throughput.

2. Determine the total number of appointments to include in the schedule template, and the appropriate mix of appointment types. Ultimately, this must be done via trial and error, using the simulator, but a good beginning point is to use the overall average appointment length for the doctor, and a starting point of 70% utilization, to set a target number of appointments as follows:

Using the data collected earlier, divide the average number of doctor minutes per visit across all appointments by 0.7. Divide the number of working minutes in the template by this value, and round to the nearest integer. This is a good starting point for the first schedule template. For example, say the average doctor visit was 10.6 minutes. 10.6 minutes/0.7=15.1 minutes. The template contains 240 minutes of working time, so 240 minutes/15.1 minutes per appointment=15.8 appointments, so there will be 16 appointments in the four-hour block.

Now the appointment group proportions are multiplied by 16 appointments to get the number of each for the schedule template. This number will be rounded up for longer appointments and down for shorter appointments as follows:
Group PS: 16 appointments*21.4%=3.4 appointments. The method will plan for 3.
Group PMDS: 16*23.8%=3.8 appointments. The method will plan for 4.
Group PMDL: 16*43.6%=7.0 appointments.
Group PL: 16*11.2%=1.8 appointments. The method will plan for 2.

Thus, the first schedule template will contain 3 PS, 4 PMDS, 7 PMDL and 2 PL appointments, for a total of 16 appointments.

Using these appointment types to identify slots in the schedule, create a schedule template for the day, using the following guidelines:

1. Use overbooking and a mix of appointment spacing to reach the target average appointment length. For instance, to get eight appointments per hour using 10-minute scheduling, schedule an appointment every 10 minutes, and double-book appointments at the beginning of and 30 minutes after the hour.
2. Alternate short and long appointment types to reduce variability. For instance, it may be decided to use 10 minute slots for two groups of appointments: the first group averages 6 minutes, while the second group averages 8 minutes. If too many appointments from the longer group are scheduled consecutively, wait times will be higher. By spreading the 6-minute group evenly amongst the 8 minute group, variability is reduced, and wait times are reduced while maintaining a high level of utilization. Note that this provides a better result than simply lumping the 6 and 8 minute groups together because the low utilization appointments cannot be used effectively for buffer unless they are identified and deliberately spread out.

3. Set a slightly faster pace (by overbooking or denser packing of appointments) during the first few appointments of the day in order to fill the pipeline more quickly and ensure staff doesn't wait needlessly on patients. Wait times will tend to be lowest during the first few appointments of the day, and wasted staff time will be highest during this period when patients arrive late or take longer than planned to be seen by staff prior to being ready for the doctor. By setting a faster pace initially, these problems are mitigated without exceeding the longer wait times that will be seen later in the day.

4. Schedule appointments with short preparation times early in the day, and late in the day, in order to get the doctors working earlier and prevent doctors from waiting on patients at the end of the day.

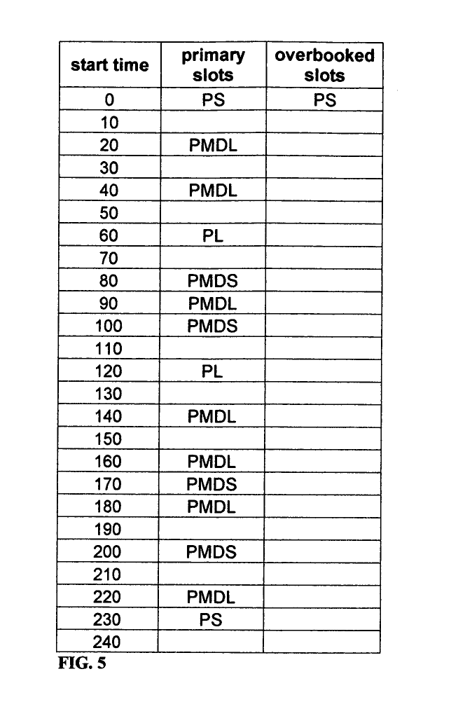

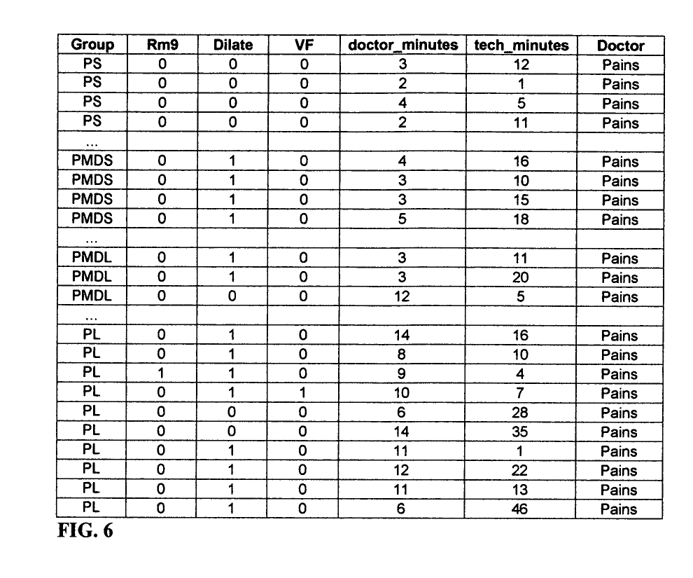

FIG. 5 shows an exemplary schedule template. Notice how this schedule uses overbooking, alternates long and short types, begins with double-booked appointments for a faster initial pace, and begins and ends with appointments from the short preparation time group.

Test the Template.

After developing a candidate template, it must be tested using Monte Carlo simulation, and then adjusted as necessary to find an acceptable balance between patient wait times, staff day length and throughput.

After the appointment timings gathered during data collection have been separated into the appropriate appointment groups as described above, these timings must be saved in a file that provides the data needed for the simulator. The simulator will then randomly select appointments from each group to use for each appointment in the template, based on the appointment types in the schedule template, then use the actual appointment data for each appointment type for each trial of the simulation.

Patient arrival times should be described statistically using standard distributions, based on a study of the difference between scheduled appointment or start times, and arrival times. For example, patient arrival times may approximate a normal distribution when compared to scheduled appointment times, and average 7 minutes early, with a standard deviation of 15 minutes. Staff may be assumed to arrive on time, or their arrival times can be similarly studied and statistically described for the simulator.

FIG. 6 shows portions of an exemplary table of actual timings and group assignments. As FIG. 6 illustrates, the group designation, based on predicted duration as described above, is labeled. Rm9 indicates the use of special equipment in a specific room which can generate patient waits. Dilate and VF are specific tests which lengthen the appointment and were important enough to be included in the simulation. Doctor_minutes and tech_minutes are the durations of the visit for these two staff types. This simulation describes a practice where technicians always see the patient first, followed by any tests, and the doctor's part of the visit is last.

The schedule template must also be fed into the simulator. FIG. 5 is an exemplary appointment template. The form in FIG. 5 shows one possible format for defining a schedule template, where the left column indicates the number of minutes past the beginning of the work period that appointments are be scheduled. For example, if the day starts at 8:00 AM, then “80” indicates appointments scheduled for 9:20 AM. The two columns at the right indicate appointment slots (there could be more columns indicating further overbooking). Where there are multiple appointments on the same row, this indicates overbooking of a given time; two patients are given the same appointment time. The letters PS, PMDS, PMDL and PL indicate appointments of these types.

Both the schedule template and the timing data must be saved in a format which the simulator can read. It is desirable to use comma separated files, which can be conveniently edited in Microsoft Excel®. The simulator then reads these files and uses them to drive the Monte Carlo simulation of the medical practice.

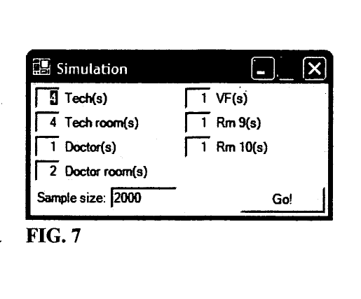

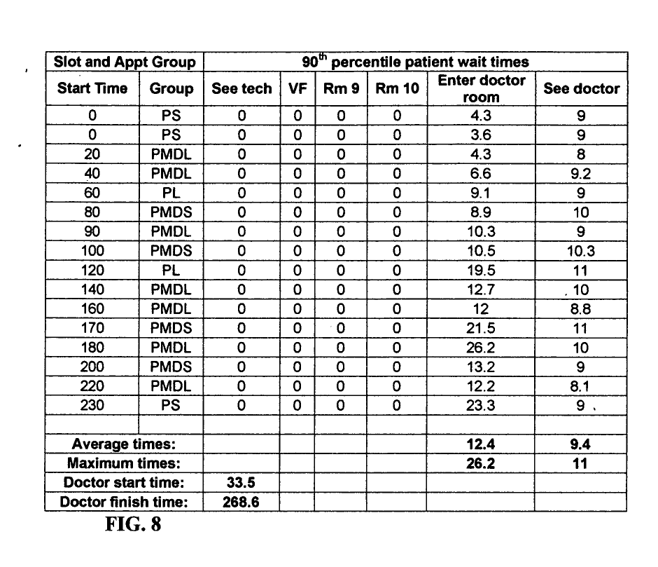

FIG. 7 is a user interface used to define resource levels required by a simulator program. As a final piece of required input, the simulator requires that the resource levels for various staff roles (the number of technicians, rooms, doctors, pieces of equipment, etc.) be defined, along with the number of trials to run, as FIG. 7 illustrates.

The output of the simulator includes wait times for each appointment of the day, for each key event simulated: seeing a technician, using a piece of equipment, seeing the doctor, etc. It also includes start and end time for the doctor (defined as the first time patients were ready to be seen, assuming the doctor was there, and the time that the last patient was done). Because these metrics are different for each of the many trials run during a simulation, the metrics are defined in terms of percentiles. The 90th percentile wait time for seeing a doctor is defined as the wait time for the patient who waited longer than 90% of the other patients in the simulation. FIG. 8 is an exemplary output table produced by the simulator program, showing 90th percentile wait times for each event during each appointment and 90th percentile doctor start and finish times. The simulator would produce similar tables for other metrics chosen for analysis, such as average and 99th percentile wait times, and 10th percentile doctor start and end times, etc. as described earlier.

As in FIG. 5, the appointment times at the left are in minutes, relative to the start of the day. For each appointment, the 90th percentile waits are given. Finally, near the bottom, the 90th percentile doctor start and finish times are listed, along with other summary statistics for analysis. Note that the results of this simulation show that wait times are zero for the tech, VF, Rm 9 and Rm 10 resources at the 90th percentile across all appointment times. In other words, 9 out of 10 patients won't wait at all for these resources during any appointment slot. However, at the 90th percentile, patients will wait for a doctor room and for the doctor.

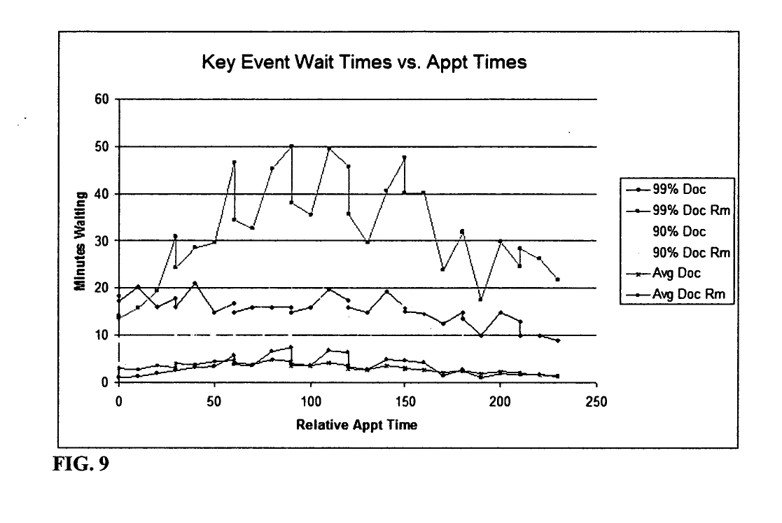

FIG. 9 is an exemplary graph of the wait time data produced by the simulator. To ease analysis of the simulator output, simulator output can be graphed as in FIG. 9, which shows the patient wait times for each appointment, where the relative appointment start time is given along the horizontal axis, and the minutes of wait at various percentiles are plotted along the vertical axis. This chart shows the 99th percentile wait times to get into a room prior to seeing the doctor (“99% Doc Rm”) growing from the beginning of the day to a maximum of about 50 minutes at about 90 minutes into the day. Assuming that the day begins at 8:00 AM, this means that 99 out of 100 patients scheduled for an appointment at 9:30 AM will wait less than 50 minutes before being shown to a room to see the doctor. The chart also shows that of all patients given a 9:30 AM appointment who have already been shown to a room, 99% will wait in the room less than 17 minutes before seeing the doctor.

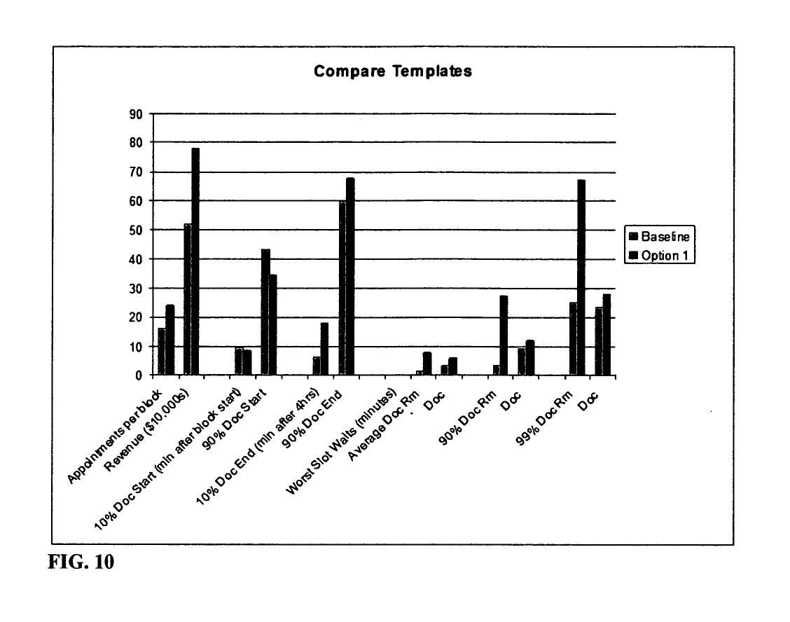

FIG. 10 is an exemplary chart which compares key metrics and patient wait times produced by the simulator program for a baseline appointment template and for a first option appointment template. The chart is useful for comparing schedule templates. It captures key metrics for one or more templates, so that these templates can be compared in terms of all three key goals: patient throughput, patient wait times, and staff workday length. FIG. 10 summarizes the simulation results for two schedule templates: “Baseline” and “Option 1.” Beginning from the left, reading each pair of columns, it shows:
1. The number of appointments in each template.
2. The approximate revenue produced by this number of appointments. The difference between these values is the approximate revenue increase expected if the Option 1 is used and all appointments are filled.
3. The start time for the doctor, in minutes from the beginning of the block, at the 10th percentile. FIG. 10 shows the doctor starting sooner than 10 minutes into the block less than 10% of the time.
4. The start time for the doctor, in minutes from the beginning of the block, at the 90th percentile. FIG. 10 shows the doctor starting later than about 43 minutes less than 10% of the time for the baseline case, and about 8 minutes earlier for Option 1.
5. The remaining columns show patient wait times for a room to see the doctor, and for the doctor. These values are shown for the average case, 90th percentile, and 99th percentile.

The simulation will assume that all appointments are filled, and will use standard Monte Carlo simulation techniques to forecast wait times. Because multi-resource simulation is complex, one possible design for such a simulation is outlined below.

Monte Carlo Simulation.

Appointments are modeled using a patient object, which is a software construct that steps through a series of events representing the key parts of a visit, such as arrival, being seated in a room, seeing a technician, using a piece of test equipment, being seated in another room to see the doctor, seeing the doctor, and finishing the appointment. A random arrival time is assigned for each patient relative to the scheduled appointment start time, and this is repeated for each trial that is run as part of the Monte Carlo simulation. As an example of the distribution of the random values used during simulation, the clinic might have patients that arrive on average 7 minutes early, with a standard deviation of 15 minutes.

The Patient Object.

Patient objects start with their next event set to the arrived state, and their next event time set to their arrival time. These objects are held in a queue called the ready list, which always remains sorted based on the time the object will be ready for its next event. The head of the queue therefore defines the current time and is the next patient to be handled. A second queue, called the waiting list, holds patients which are waiting on resources that are not currently available. The head of the waiting list is the patient who has been waiting the longest. After the next ready patient is processed, the entire waiting list is processed from longest waiter to shortest waiter, and each patient is tested to see if the resources he is waiting for have become available. After the waiting list is processed, the ready patient either begins his next event and is sorted back into the ready list based on when he will complete this next event, or he begins waiting and is added to the waiting list, depending on whether resources are available for the next event in his visit.

When a patient is finished with all events, he is not added back to either queue (ready list or waiting list). When the queues are empty, the simulation trial is finished.

The pseudo code below shows how patients are handled during simulation:

| | |
|---|---|
| CurrentTime = 0 | |
| while ReadyList not empty | |
| { | |
| CurrentPatient = ReadyList.First | // get next ready patient |
| previousTime = CurrentTime | // remember last ready |
| time | |
| CurrentTime = CurrentPatient.ReadyTime | // set new ready time |

```
    Free resources just used and not needed for CurrentPatient's next
event
    Advance CurrentPatient.NextEvent to next event assigned to this
patient
    Remove CurrentPatient from ReadyList
    // process in order from longest waiter to shortest
    for each waitingPatient in WaitingList
    {
        ElapsedTime = CurrentTime − previousTime
        // Add elapsed time to accumulated wait time
        LogWaitTime(waitingPatient, ElapsedTime, TrialIndex)
        if resources available for waitingPatient's next event
        {
            Allocate resources required for next event not
                already allocated
            waitingPatient.nextEventTime = CurrentTime +
                waitingPatient.NextEventDuration
            Remove waitingPatient from WaitingList
            Add waitingPatient to ReadyList
        }
    }
    if CurrentPatient not Finished
    {
        if resources available for CurrentPatient's next event
        {
            Allocate resources required for next event not
                already allocated
            CurrentPatient.nextEventTime = CurrentTime +
                CurrentPatient.NextEventDuration
            Add CurrentPatient to ReadyList
            if no doctor start time recorded and this patient's
                next event will use doctor
            {
                doctorStart = CurrentTime
            }
            }
            else Append CurrentPatient to WaitingList
    }
    // The below assumes doctor is always the last part of visit
    else doctorFinish[TrialIndex] = CurrentTime
}
```

Staff, Rooms and Equipment

Staff, rooms and equipment are represented by counters indicating how many of each is available. Pooled resources such as technicians are not matched with a patient until the time of service. These are represented as a single named resource pool, with a quantity equal to the number working that day. Non-pooled resources, such as doctors who are assigned to patients at the time the appointment is scheduled, are each given their own unique resource identifier, with a quantity of one. This way, doctors are not assumed to see other doctors' patients.

Each event that the patient object cycles through is defined in terms of the resources it requires. The simulator tests for whether these resources are available prior to assuming their use as described above.

After repeating for the desired number of simulation trials, for each metric (wait times, idle times, utilization) collected, calculate the desired summary statistics. For instance, for each appointment, calculate the 90th percentile wait time for each segment of the appointment, and for each staff member, calculate begin and end of workday statistics.

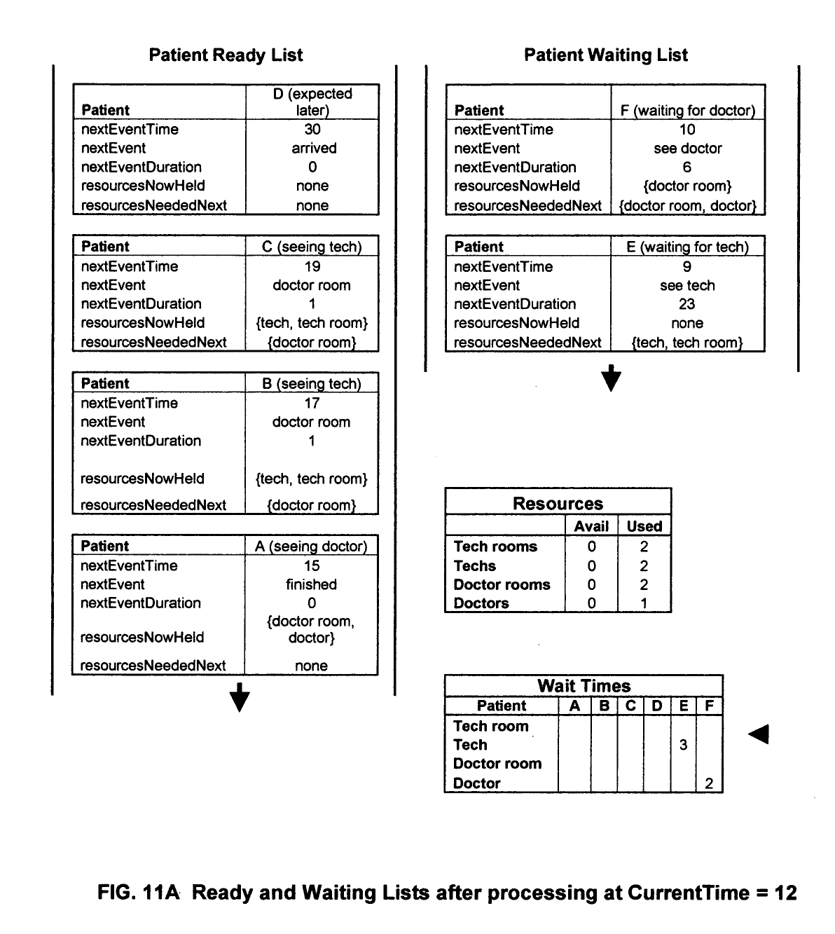

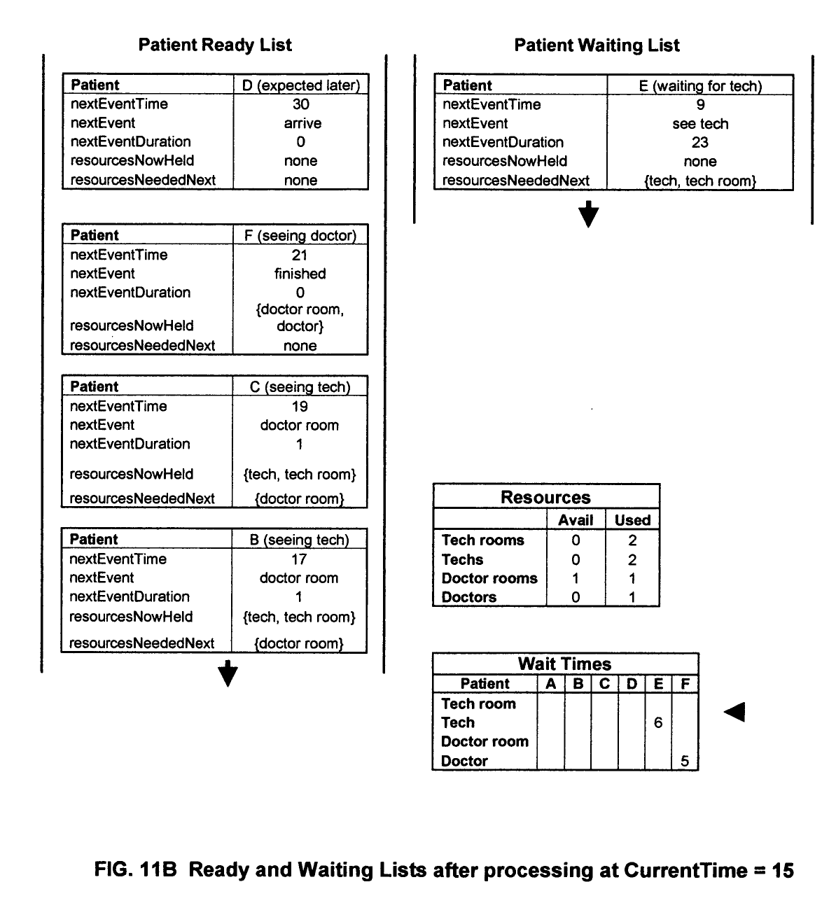

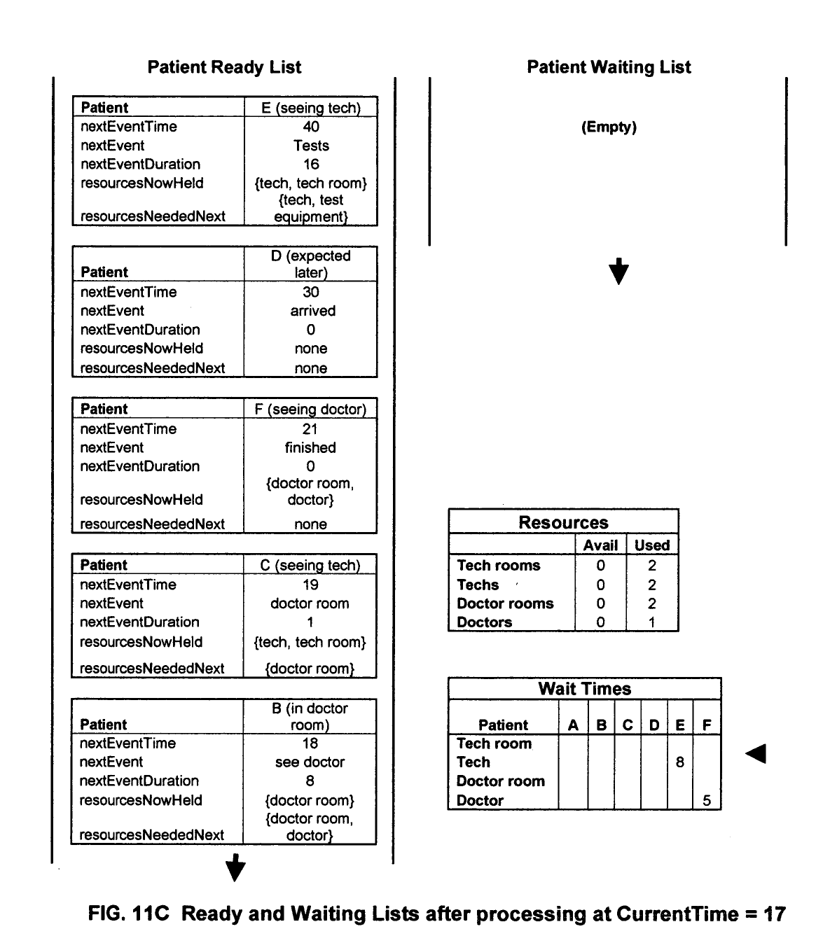

Next, this description will step through the patient object processing loop and show how patients move through the two queues, and how wait times are calculated. The example below traces the processing illustrated in FIGS. 11A-11C. FIG. 11A is a schematic diagram showing the result of simulating a medical practice at a first time (CurrentTime=12) using Monte Carlo simulation. FIG. 11B is a schematic diagram showing the result of simulating a medical practice at a later time (CurrentTime=15) than that shown in FIG. 11A, using Monte Carlo simulation. FIG. 11C is a schematic diagram showing the result of simulating a medical practice at a later time (CurrentTime=17) than that shown in FIG. 11B, using Monte Carlo simulation.

At Time 12 (See FIG. 11A)

The example begins with the situation as drawn in FIG. 11A. The office is staffed with two technicians and one doctor, and there are two rooms for the technicians to share and two for the doctor. Five patients are in the office, and another patient (D) is expected later.

At the point processing is finished at time 12 (meaning 12 minutes past the beginning of the block of time being simulated), there are four patients in the ready list (patients A, B, C and D) and two in the waiting list (patients E and F). Patient A is at the head of the ready list, and so its next event time (15) will define the current time for the next processing loop. Patient A is currently seeing the doctor. Its next event is finished, meaning it will be finished when the current time is 15. It is currently using a doctor room and a doctor, and these will both be freed at time 15, since the resources needed next are “none.”

Patient B is seeing a technician, and at time 17 will be done with the technician and ready for its next event, which is to be shown to a doctor room. The doctor room, however, may or may not be ready at time 17, as will be seen. Patient B is currently using a technician and technician room, and will need only a doctor room next. Patient B's next event duration is 1, meaning it will take one minute to move the patient into the doctor room, once the room is available. Patient C is also seeing a technician, and will be ready for a doctor room at time 19.

Patient D has not arrived yet. Its next event is to arrive, which will happen at time 30. No resources are required for the arrival event, and none are currently being used.

Patient E is waiting for a technician. It has been waiting 3 minutes already, as the wait times chart shows. Its next event duration is 23 minutes, meaning that it will take 23 minutes with the technician once one is available. This duration was assigned randomly as part of the initialization step of the Monte Carlo simulation, described earlier. This patient is using no resources currently (sitting in the lobby waiting), but will need a technician and technician room to start its next event.

Patient F is waiting for the doctor, and has been waiting 2 minutes already. Patient F is in the doctor room, but needs the doctor in order to start its next event, and the doctor is not available. It will spend 6 minutes with the doctor (the next event duration) once the doctor is available. ps At Time 15 (See FIG. 11B)

As the processing begins, the patient at the head of ready list (patient A) is removed from the ready list and held aside. Its next event time defines the current time, which is updated to 15. Patient A needs nothing for its next event, so all its resources are freed: doctor room and doctor. The resource list in FIG. 11B is updated to reflect this, showing 1 doctor available and 1 doctor room available. The next event type remains set to finished for patient A.

The waiting list is scanned from the head to the end, so patient E is processed first: its wait time is updated to include the three minutes between the current time (15) and the previous loop time (12), bringing its total wait to 6 minutes. This is recorded in a three-dimensional array of wait times, indexed by resource, appointment and trial number. Patient E needs a technician and technician room, but neither is available, so E remains in the waiting list queue.

Patient F is processed next since it is next in the queue. First, three minutes are added to its wait time for the doctor, bringing its total wait to five minutes (see “Wait Times” table to right of queue). Patient F needs a doctor and doctor room, and these are now available, having been freed by patient A. Available resources are reduced to reflect patient F's use of them, returning the doctor and doctor room available counts to zero. Patient F's next event is set to finished, and the next event time is set to the current time+6=21. Recall that 6 was the amount of time this patient was to spend with the doctor. The next event duration is set to zero. Resources now held are updated to doctor and doctor room. Resources needed next (when finished) are “none.” Finally, patient F is sorted back into the ready list, based on its next event time. This places it after patient C, meaning that patient F will finish its appointment after patient C is ready for its next event.

Since patient A is finished, it is removed from the queue.

At Time 17 (See FIG. 11C)

Patient B is at the head of the ready list when processing begins, so the current time is set to its next event time (17). Patient B is now finished seeing the technician, so the technician and technician room are freed.

The waiting list is then processed. Patient E's wait time for the technician is again updated to include the minutes waited since the last processing loop (17−15=2). Its wait time for the technician is increased by 2 to 8. Since a technician and technician room are now available because B just finished using them, E can now use them. Available resources are adjusted to show E's use of a technician and technician room, bringing the available resource values back to zero for these. Patient E's next event time is set to 17+23=40, meaning it will finish with the technician at time 40, and E is moved to the ready list and placed after Patient D, since E's next event will happen after D's next event.

Patient B is not yet finished. It requires a doctor room for its next event, and one is now available, so the resource list is updated to reflect that doctor room in use by patient B, bringing the total to zero again. Its next event type is set to see doctor, and the next event time is set to one minute from the current time, to 18. This reflects that moving to the doctor room requires about a minute of time, and at that point, the patient will either see the doctor, or will begin waiting for the doctor. B is placed at the head of the ready list, since its next event time is earlier than any other patient's next event.

Refine the Template.

After studying the wait time results, before altering the template, make adjustments to improve staff balancing as needed and re-run the simulation. Then, if wait times are still too high, reduce utilization by reducing the number of appointments, by reducing the threshold values for which appointment lengths are assigned to each type, or by altering the arrangement of appointments in the template. Wait times can also be reduced by reducing variability, which can be accomplished by developing a more powerful model to predict appointment lengths, or through better matching of appointments to create pairs or groups of appointments with lower average variability, as discussed earlier.

Improve the doctor start and end times by scheduling appointments with short preparation times prior to seeing the doctor at the beginning and end of each work period (the period from starting to serve patients to taking a long break for lunch or end of day), and by double or triple-booking the first appointment of the work period. As necessary, remove appointments at the end of the working period to shorten the working time for the doctor. Then repeat the simulation to test the improvements. The goal is to maximize the number of appointments in each working period while providing a consistent, acceptable level of service and providing a workday acceptable to staff.

Schedule the Appointments.

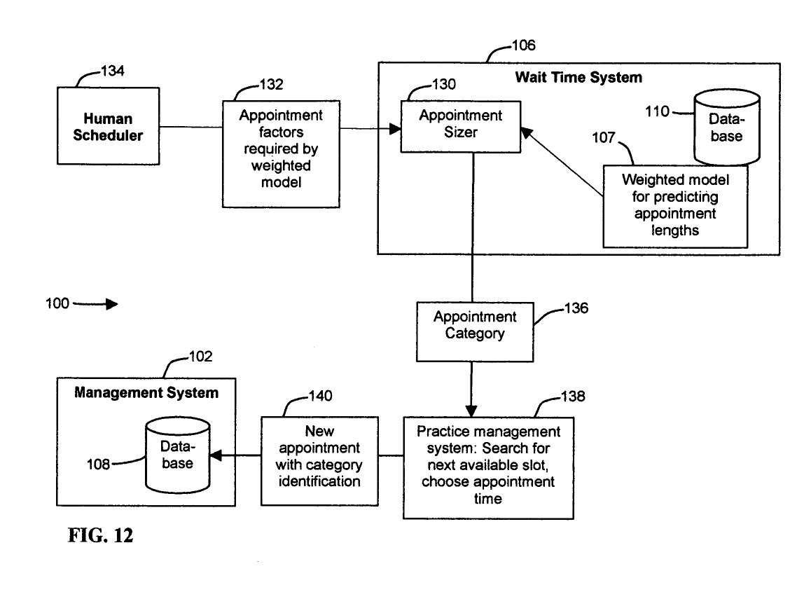

See FIG. 12, a flow diagram for the steps of scheduling the appointment using the present invention. This diagram shows the system 100 when it is used to schedule an appointment. The wait time system 100 includes an appointment sizer 130, which receives appointment factors required by the weighted statistical model (block 132). The appointment factors are produced in response to inputs entered by a human scheduler 134. The appointment sizer 130 produces an appointment category (block 136). The appointment category is used to invoke a search for a next available slot in the schedule, and to choose an appointment time (block 138). The resulting new appointment (block 140) is entered in the database 108 in the management system 102.

Once the template has been developed, it can be used to guide scheduling. First, the template used for Monte Carlo simulation must be translated into a template suitable for scheduling. Practice management systems such as GE Centricity® that support schedule templates can be used to automate the search for an available appointment in the following way:

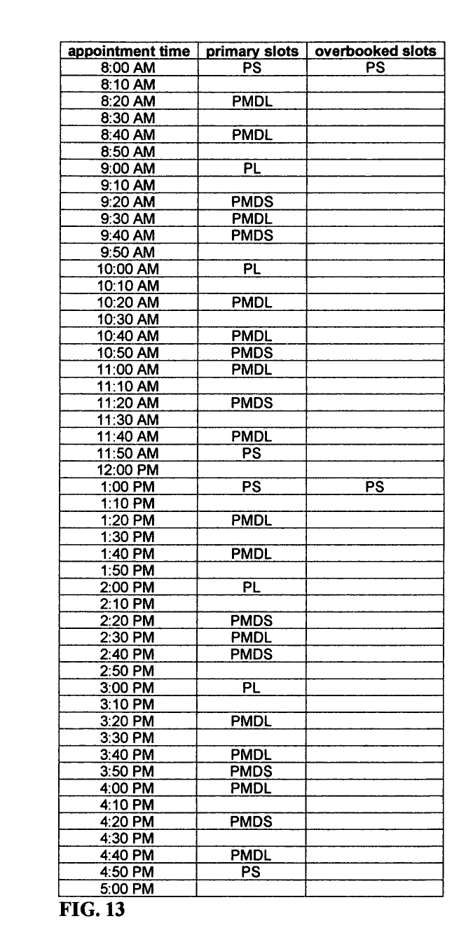

Suppose the schedule template in FIG. 5 was the one that is desired to use to guide scheduling. Because this schedule template is for a four-hour block, it must be duplicated in the morning and afternoon in order to translate the schedule template into an 8-hour schedule. It is also necessary to translate the zero-based start times to actual appointment times. To do this, the relative time zero is simply replaced with the absolute start time (such as 8:00 AM or 1:00 PM) for the morning and afternoon, and then set each appointment at the time that is N minutes after this time, where N is the zero-based start time in FIG. 5. FIG. 13 is an exemplary appointment template for one doctor, ready to be used to guide actual appointment scheduling. This completed schedule template shows a day that starts at 8:00 AM with afternoon appointments starting at 1:00 PM, with the appointment times set appropriately.

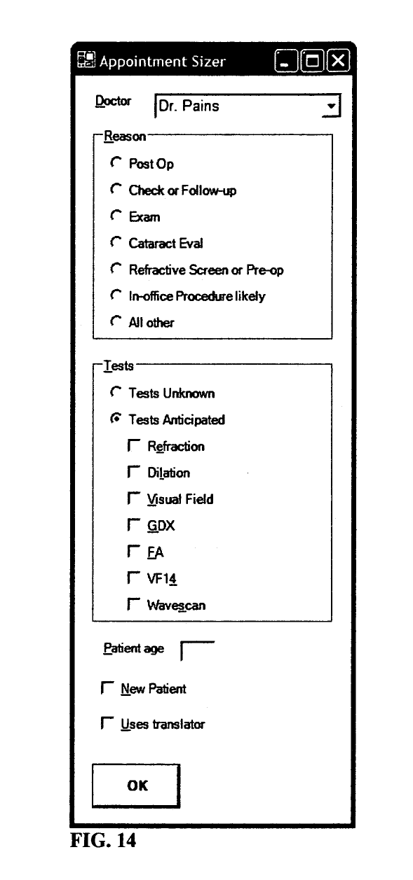

The category designations would be used to build a template in a practice management system such as GE Centricity®. Once the template is entered to match the schedule above, a second program must be written to accept as inputs the factors required for the predictive model, and assign each new appointment to the appropriate category (PS, PMDS, PMDL or PL in this example). This category value would then be used by the scheduler in the practice management system to search for the next available appointment. FIG. 14 shows an exemplary user interface displayed by a program used by the scheduler to assign each new appointment to the appropriate group for scheduling.

The program illustrated in FIG. 14 is used as follows: A patient calls to request a post-operative (post-op) exam with Dr. Pains. The scheduler selects the following options: “Dr. Pains”, “Post-op”, “Tests Anticipated: Refraction, Visual Field”, indicates the patient's age, and chooses “New Patient.” The scheduler then presses “OK” and the program uses these factor values, along with the weighted model for predicting appointment durations to calculate an expected appointment duration for the doctor and the technician. These predicted durations are compared to the centers for each appointment group, and the program determines the appointment category as PS. A large “PS” is displayed next to the OK button in the Appointment Sizer. The scheduler switches to GE Centricity®, her management program, to schedule the appointment, brings up the search window, enters “PS” as the appointment type to search for in GE Centricity®, and GE Centricity® provides a list of available times for this appointment.

If the practice management system does not support templates, the template can be printed and matched manually, using the same program to designate the correct category for each appointment. As appointments are entered in the schedule, the scheduler would annotate them with the category designation to facilitate matching appointment types.

### SUMMARY

The combination of a time and motion study, appointment grouping based on statistical analysis, and simulation enable a set of benefits that cannot be attained using any one of these approaches alone:

The time and motion study identifies underutilized key resources, allowing throughput increases without violating wait time goals.

The time and motion study provides accurate data for the statistical model, yielding accurate conclusions about what factors do and do not influence visit durations, and valuable data regarding performance and utilization of key resources and staff.

The statistical analysis enables appointment group assignments with more consistent visit durations within each group, and greater differences across groups. These greater differences across groups and smaller differences within groups enable greater efficiency; wait times and throughput can be simultaneously improved.

The appointment groups and time and motion study enable an accurate model to be built of proposed new schedules using Monte Carlo simulation. This simulation allows a specific set of options to be developed and refined, by quantifying wait times for different schedule templates. This allows the service organization to maximize customer throughput without violating its chosen constraints on customer wait times and staff workday length.

By combining these elements and integrating them into existing practice management systems, this invention improves efficiency and service levels while minimizing changes to current practices.

While the foregoing is a detailed description of the preferred embodiment of the invention, there are many alternative embodiments of the invention that would occur to those skilled in the art and which are within the scope of the present invention. Accordingly, the present invention is to be determined by the following claims.

1. A method for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the method comprising the steps of:
(a) measuring the lengths of time required from staff members and key resources by a statistically significant sample of appointments;
(b) developing one or more schedule templates that designate how appointments should be scheduled, using a single appointment type for each staff member being scheduled;
(c) testing and refining the one or more schedule templates using Monte Carlo simulation and the measured lengths of time;
(d) selecting one of the one or more schedule templates for use in scheduling appointments for the first subject organization; and
(e) scheduling appointments according to the selected schedule template.

2. The method of claim 1, wherein step (d) comprises evaluating the one or more schedule templates according to one or more criteria.

3. A method for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the method comprising the steps of:
(a) developing a weighted statistical model for a typical organization having staff members and key resources with a typical set of appointments, the weighted statistical model describing the factors expected to predict the length of time that a given appointment requires from the staff members of the typical organization and from the key resources;
(b) collecting data for the first subject organization to eliminate factors that do not provide significant predictive power, and to determine the weights of the weighted statistical model that are required to accurately predict the length of time required from staff members for a given appointment based on the factors described by the weighted statistical model;
(c) adjusting the weights of the weighted statistical model in accordance with the data collected in step (b);
(d) segregating appointments into distinct appointment groups based on predicted time spent with staff members and/or one or more key resources;
(e) developing one or more schedule templates that designate how appointments from the distinct appointment groups should be scheduled and combined in order to increase throughput;
(f) testing and refining the schedule templates using Monte Carlo simulation;
(g) collecting appointment data from at least one staff member who inputs prospective appointments into the management system for the first subject organization, or from the management system; and
(h) designating the distinct appointment group each new appointment belongs to as it is scheduled, using the weighted statistical model so that it can be matched to a schedule template and scheduled at an appropriate time.

4. The method of claim 3, further comprising the step of:
(i) calculating, for a given level of weighted statistical confidence, an estimate of the wait time for a given appointment.

5. The method of claim 3, further comprising the step of:
(j) displaying the calculated estimated wait times in an annotated schedule of appointments.

6. The method of claim 3, further comprising the step of: (i) storing the schedule template developed and tested in steps a)-h) into the management system in the form of a template that can be utilized by the management system for matching appointment types to specific slots.

7. The method of claim 3, further comprising the steps of:
(i) calculating, for a given level of weighted statistical confidence, an estimate of the wait time for a given appointment; and
(j) displaying the calculated estimated wait time in an annotated schedule of appointments.

8. The method of claim 7, further comprising the steps of:
(k) allowing a member of the staff to modify the start time of an appointment in the annotated schedule of appointments;
(l) calculating the changes in wait times due to the modified start time; and
(m) displaying the schedule of appointments, annotated with expected wait times, as it is changed by the modified start time.

9. The method of claim 3, further comprising the steps of:
(n) adding an additional appointment which does not match any of the slots in the existing schedule template;
(o) choosing the best start times and assessing the impact of adding the incremental appointment for said additional appointment by iteratively predicting wait times for a set of possible start times, and
(p) presenting a list of those start times which result in acceptable wait times after adding the additional appointment.

10. The method of claim 3, further comprising the steps of:
(q) recalculating new wait time estimates for all remaining appointments for a given day, based on the impact of accepting an unscheduled visit or of a no-show during the day; and
(r) displaying the recalculated new wait time estimates in an annotated schedule of appointments.

11. A method for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the method comprising the steps of:
(a) developing a weighted statistical model for a typical organization having staff members and key resources with a typical set of appointments, the weighted statistical model describing the factors expected to predict the length of time that a given appointment requires from the staff members of the typical organization and from the key resources;
(b) collecting data for the first subject organization to eliminate factors that do not provide significant predictive power, and to determine the weights of the weighted statistical model that are required to accurately predict the length of time required from staff members for a given appointment based on the factors described by the weighted statistical model;
(c) adjusting the weights of the weighted statistical model in accordance with the data collected in step (b);
(d) applying cluster analysis to segregate appointments into distinct appointment groups based on predicted time spent with staff members and/or one or more key resources;
(e) developing one or more schedule templates that designate how appointments from the distinct appointment groups should be scheduled and combined in order to increase throughput;
(f) testing and refining the schedule templates using Monte Carlo simulation[bcg3];
(g) collecting appointment data from at least one staff member who inputs prospective appointments into the management system for the first subject organization, or from the management system; and
(h) designating the distinct appointment group each new appointment belongs to as it is scheduled, using the weighted statistical model so that it can be matched to a schedule template and scheduled at an appropriate time.

12. The method of claim 11, further comprising the step of:
(i) calculating, for a given level of weighted statistical confidence, an estimate of the wait time for a given appointment.

13. The method of claim 11, further comprising the step of:
(j) displaying the calculated estimated wait times in an annotated schedule of appointments.

14. The method of claim 11, further comprising the step of: (i) storing the schedule template developed and tested in steps a-h into the management system in the form of a template that can be utilized by the management system for matching appointment types to specific slots.

15. The method of claim 11, further comprising the steps of:
(i) calculating, for a given level of weighted statistical confidence, an estimate of the wait time for a given appointment; and
(j) displaying the calculated estimated wait time in an annotated schedule of appointments.

16. The method of claim 15, further comprising the steps of:
(k) allowing a member of the staff to modify the start time of an appointment in the annotated schedule of appointments;
(l) calculating the changes in wait times due to the modified start time; and
(m) displaying the schedule of appointments, annotated with expected wait times, as it is changed by the modified start time.

17. The method of claim 11, further comprising the steps of:
(n) adding an additional appointment which does not match any of the slots in the existing schedule template; and
(o) choosing the best start times and assessing the impact of adding the incremental appointment for said additional appointment by iteratively predicting wait times for a set of possible start times, and
(p) presenting a list of those start times which result in acceptable wait times after adding the additional appointment.

18. The method of claim 11, further comprising the steps of:
(q) recalculating new wait time estimates for all remaining appointments for a given day, based on the impact of accepting an unscheduled visit or of a no-show during the day; and
(r) displaying the recalculated new wait time estimates in an annotated schedule of appointments.

19. A method for predicting wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the method comprising the steps of:
(a) segregating appointments into distinct appointment groups based on existing appointment types;
(b) collecting timing data for the first subject organization for each appointment group;
(c) describing existing scheduling practices in the form of a schedule template which utilizes the distinct appointment groups created;
(d) using Monte Carlo simulation and the timing data collected for each of the distinct appointment groups to predict customer wait times for current scheduling policies and practices.

20. The method of claim 19, wherein step d) further comprises altering one or more of the following: the number, length and/or start times of appointments; the proportion of various appointment groups within the schedule; staff start and end times; staffing and resource levels; and/or policies about turning late patients away.

21. A method for creating earlier and more reliable start times in a working period for staff members of an organization having one or more staff members who use a schedule of appointments for its customers, and a service pipeline involving more than one process step, such that at least one staff member must wait on preparatory steps before seeing a customer, the method comprising the steps of:
(a) minimizing the duration of the preparatory steps during an initial portion of the working period by identifying those appointments which require shorter preparatory times and scheduling the appointments with shorter preparatory times in the initial portion of the working period.

22. A method for creating earlier and more reliable finish times in a working period for staff members of an organization having one or more staff members who use a schedule of appointments for its customers, and a service pipeline involving more than one process step, such that at least one staff member must wait on preparatory steps before seeing a customer, the method comprising the steps of:
(a) minimizing the duration of the preparatory steps during a final portion of the working period by identifying those appointments which require shorter preparatory times and scheduling the appointments with shorter preparatory times in the final portion of the working period.

23. A method for increasing throughput and controlling appointment wait times for customers of a professional office having staff members and key resources subject to policies of the professional office, the professional office having one or more staff members who use a management system that produces customer and schedule data that allows its staff members to manage the operation of the professional office based on prospective appointments for its customers, the prospective appointments being input into the management system by the one or more of its staff members, the key resources including staff rooms and professional equipment, the method comprising the steps of:
(a) measuring the lengths of time required from staff members and key resources by a statistically significant sample of appointments;
(b) developing one or more schedule templates that designate how appointments should be scheduled, using a single appointment type for each staff member being scheduled;
(c) testing and refining the one or more schedule templates using Monte Carlo simulation and the measured lengths of time;
(d) selecting one of the one or more schedule templates for use in scheduling appointments for the professional office; and
(e) scheduling appointments according to the selected schedule template.

24. The method of claim 23, wherein the professional office is an office of a medical practice, a dental practice, or a legal practice.

25. An apparatus for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
a computer programmed to measure the lengths of time required from staff members and key resources by a statistically significant sample of appointments;
a computer programmed to develop one or more schedule templates that designate how appointments should be scheduled, using a single appointment type for each staff member being scheduled;
a computer programmed to test and refine the one or more schedule templates using Monte Carlo simulation and the measured lengths of time;
a computer programmed to select one of the one or more schedule templates for use in scheduling appointments for the first subject organization; and
a computer programmed to schedule appointments according to the selected schedule template.

26. The apparatus of claim 25, wherein the computer programmed to select one of the one or more schedule templates is also programmed to evaluate the one or more schedule templates according to one or more criteria.

27. An apparatus for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
a computer programmed to develop a weighted statistical model for a typical organization having staff members and key resources with a typical set of appointments, the weighted statistical model describing the factors expected to predict the length of time that a given appointment requires from the staff members of the typical organization and from the key resources;
a computer programmed to collect data for the first subject organization to eliminate factors that do not provide significant predictive power, and to determine the weights of the weighted statistical model that are required to accurately predict the length of time required from staff members for a given appointment based on the factors described by the weighted statistical model;
a computer programmed to adjust the weights of the weighted statistical model in accordance with the data collected by the computer programmed to collect data for the first subject organization to eliminate factors that do not provide significant predictive power;
a computer programmed to segregate appointments into distinct appointment groups based on predicted time spent with staff members and/or one or more key resources;
a computer programmed to develop one or more schedule templates that designate how appointments from the distinct appointment groups should be scheduled and combined in order to increase throughput;
a computer programmed to test and refine the schedule templates using Monte Carlo simulation;
a computer programmed to collect appointment data from at least one staff member who inputs prospective appointments into the management system for the first subject organization, or from the management system; and
a computer programmed to designate the distinct appointment group each new appointment belongs to as it is scheduled, using the weighted statistical model so that it can be matched to a schedule template and scheduled at an appropriate time.

28. The apparatus of claim 27, further comprising a computer programmed to calculate, for a given level of weighted statistical confidence, an estimate of the wait time for a given appointment.

29. The apparatus of claim 27, further comprising a computer programmed to display the calculated estimated wait times in an annotated schedule of appointments.

30. The apparatus of claim 27, further comprising a computer programmed to store the tested schedule template into the management system in the form of a template that can be utilized by the management system for matching appointment types to specific slots.

31. The apparatus of claim 27, further comprising a computer programmed to calculate, for a given level of weighted statistical confidence, an estimate of the wait time for a given appointment; and
a display device to display the calculated estimated wait time in an annotated schedule of appointments.

32. The apparatus of claim 31, further comprising a computer programmed to allow a member of the staff to modify the start time of an appointment in the annotated schedule of appointments;
a computer programmed to calculate the changes in wait times due to the modified start time; and
a display device to display the schedule of appointments, annotated with expected wait times, as it is changed by the modified start time.

33. The apparatus of claim 27, further comprising a computer programmed to add an additional appointment which does not match any of the slots in the existing schedule template;
a computer programmed to choose the best start times and assessing the impact of adding the incremental appointment for said additional appointment by iteratively predicting wait times for a set of possible start times, and
a display device to display a list of those start times which result in acceptable wait times after adding the additional appointment.

34. The apparatus of claim 27, further comprising:
a computer programmed to recalculate new wait time estimates for all remaining appointments for a given day, based on the impact of accepting an unscheduled visit or of a no-show during the day; and
a display device to display the recalculated new wait time estimates in an annotated schedule of appointments.

35. An apparatus for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
a computer programmed to develop a weighted statistical model for a typical organization having staff members and key resources with a typical set of appointments, the weighted statistical model describing the factors expected to predict the length of time that a given appointment requires from the staff members of the typical organization and from the key resources;
a computer programmed to collect data for the first subject organization to eliminate factors that do not provide significant predictive power, and to determine the weights of the weighted statistical model that are required to accurately predict the length of time required from staff members for a given appointment based on the factors described by the weighted statistical model;
a computer programmed to adjust the weights of the weighted statistical model in accordance with the data collected by the computer programmed to collect data;
a computer programmed to apply cluster analysis to segregate appointments into distinct appointment groups based on predicted time spent with staff members and/or one or more key resources;
a computer programmed to develop one or more schedule templates that designate how appointments from the distinct appointment groups should be scheduled and combined in order to increase throughput;
a computer programmed to test and refine the schedule templates using Monte Carlo simulation;
a computer programmed to collect appointment data from at least one staff member who inputs prospective appointments into the management system for the first subject organization, or from the management system; and
a computer programmed to designate the distinct appointment group each new appointment belongs to as it is scheduled, using the weighted statistical model so that it can be matched to a schedule template and scheduled at an appropriate time.

36. The apparatus of claim 35, further comprising a computer programmed to calculate, for a given level of weighted statistical confidence, an estimate of the wait time for a given appointment.

37. The apparatus of claim 35, further comprising a display to display the calculated estimated wait times in an annotated schedule of appointments.

38. The apparatus of claim 35, further comprising a computer programmed to store the developed and tested schedule template into the management system in the form of a template that can be utilized by the management system for matching appointment types to specific slots.

39. The apparatus of claim 35, further comprising:
a computer programmed to calculate, for a given level of weighted statistical confidence, an estimate of the wait time for a given appointment; and
a display device to display the calculated estimated wait time in an annotated schedule of appointments.

40. The apparatus of claim 39, further comprising:
a computer programmed to allow a member of the staff to modify the start time of an appointment in the annotated schedule of appointments;
a computer programmed to calculate the changes in wait times due to the modified start time; and
a display device to display the schedule of appointments, annotated with expected wait times, as it is changed by the modified start time.

41. The apparatus of claim 35, further comprising:
a computer programmed to add an additional appointment which does not match any of the slots in the existing schedule template;
a computer programmed to choose the best start times and assessing the impact of adding the incremental appointment for said additional appointment by iteratively predicting wait times for a set of possible start times; and
a display device to present a list of those start times which result in acceptable wait times after adding the additional appointment.

42. The apparatus of claim 35, further comprising:
a computer programmed to recalculate new wait time estimates for all remaining appointments for a given day, based on the impact of accepting an unscheduled visit or of a no-show during the day; and
a display device to display the recalculated new wait time estimates in an annotated schedule of appointments.

43. An apparatus for predicting wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
a computer programmed to segregate appointments into distinct appointment groups based on existing appointment types;
a computer programmed to collect timing data for the first subject organization for each appointment group;
a computer programmed to describe existing scheduling practices in the form of a schedule template which utilizes the distinct appointment groups created;
a computer programmed to use Monte Carlo simulation and the timing data collected for each of the distinct appointment groups to predict customer wait times for current scheduling policies and practices.

44. The apparatus of claim 43, wherein the computer programmed to use Monte Carlo simulation further alters one or more of the following: the number, length and/or start times of appointments; the proportion of various appointment groups within the schedule; staff start and end times; staffing and resource levels; and/or policies about turning late patients away.

45. An apparatus for creating earlier and more reliable start times in a working period for staff members of an organization having one or more staff members who use a schedule of appointments for its customers, and a service pipeline involving more than one process step, such that at least one staff member must wait on preparatory steps before seeing a customer, the apparatus comprising:
a computer programmed to minimize the duration of the preparatory steps during an initial portion of the working period by identifying those appointments which require shorter preparatory times and scheduling the appointments with shorter preparatory times in the initial portion of the working period.

46. An apparatus for creating earlier and more reliable finish times in a working period for staff members of an organization having one or more staff members who use a schedule of appointments for its customers, and a service pipeline involving more than one process step, such that at least one staff member must wait on preparatory steps before seeing a customer, the apparatus comprising:
a computer programmed to minimize the duration of the preparatory steps during a final portion of the working period by identifying those appointments which require shorter preparatory times and scheduling the appointments with shorter preparatory times in the final portion of the working period.

47. An apparatus for increasing throughput and controlling appointment wait times for customers of a professional office having staff members and key resources subject to policies of the professional office, the professional office having one or more staff members who use a management system that produces customer and schedule data that allows its staff members to manage the operation of the professional office based on prospective appointments for its customers, the prospective appointments being input into the management system by the one or more of its staff members, the key resources including staff rooms and professional equipment, the apparatus comprising:
a computer programmed to measure the lengths of time required from staff members and key resources by a statistically significant sample of appointments;
a computer programmed to develop one or more schedule templates that designate how appointments should be scheduled, using a single appointment type for each staff member being scheduled;
a computer programmed to test and refine the one or more schedule templates using Monte Carlo simulation and the measured lengths of time;
a computer programmed to select one of the one or more schedule templates for use in scheduling appointments for the professional office; and
a computer programmed to schedule appointments according to the selected schedule template.

48. The apparatus of claim 47, wherein the professional office is an office of a medical practice, a dental practice, or a legal practice.

49. An apparatus for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
means for measuring the lengths of time required from staff members and key resources by a statistically significant sample of appointments;
means for developing one or more schedule templates that designate how appointments should be scheduled, using a single appointment type for each staff member being scheduled;
means for testing and refining the one or more schedule templates using Monte Carlo simulation and the measured lengths of time;
means for selecting one of the one or more schedule templates for use in scheduling appointments for the first subject organization; and
means for scheduling appointments according to the selected schedule template.

50. An apparatus for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
means for developing a weighted statistical model for a typical organization having staff members and key resources with a typical set of appointments, the weighted statistical model describing the factors expected to predict the length of time that a given appointment requires from the staff members of the typical organization and from the key resources;
means for collecting data for the first subject organization to eliminate factors that do not provide significant predictive power, and for determining the weights of the weighted statistical model that are required to accurately predict the length of time required from staff members for a given appointment based on the factors described by the weighted statistical model;
means for adjusting the weights of the weighted statistical model in accordance with the data collected by the computer programmed to collect data for the first subject organization to eliminate factors that do not provide significant predictive power;
means for segregating appointments into distinct appointment groups based on predicted time spent with staff members and/or one or more key resources;
means for developing one or more schedule templates that designate how appointments from the distinct appointment groups should be scheduled and combined in order to increase throughput;
means for testing and refining the schedule templates using Monte Carlo simulation;
means for collecting appointment data from at least one staff member who inputs prospective appointments into the management system for the first subject organization, or from the management system; and
means for designating the distinct appointment group each new appointment belongs to as it is scheduled, using the weighted statistical model so that it can be matched to a schedule template and scheduled at an appropriate time.

51. An apparatus for increasing throughput and controlling appointment wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
means for developing a weighted statistical model for a typical organization having staff members and key resources with a typical set of appointments, the weighted statistical model describing the factors expected to predict the length of time that a given appointment requires from the staff members of the typical organization and from the key resources;
means for collecting data for the first subject organization to eliminate factors that do not provide significant predictive power, and for determining the weights of the weighted statistical model that are required to accurately predict the length of time required from staff members for a given appointment based on the factors described by the weighted statistical model;
means for adjusting the weights of the weighted statistical model in accordance with the data collected by the computer programmed to collect data;
means for applying cluster analysis to segregate appointments into distinct appointment groups based on predicted time spent with staff members and/or one or more key resources;
means for developing one or more schedule templates that designate how appointments from the distinct appointment groups should be scheduled and combined in order to increase throughput;
means for testing and refining the schedule templates using Monte Carlo simulation;
means for collecting appointment data from at least one staff member who inputs prospective appointments into the management system for the first subject organization, or from the management system; and
means for designating the distinct appointment group each new appointment belongs to as it is scheduled, using the weighted statistical model so that it can be matched to a schedule template and scheduled at an appropriate time.

52. An apparatus for predicting wait times for customers of a first subject organization having staff members and key resources subject to policies of the first subject organization, the first subject organization having one or more staff members who use a management system that produces customer and schedule data that allows its staff members to manage the operation of the first subject organization based on prospective appointments for its customers, the prospective appointments being input into the management system by the one or more of its staff members, the key resources including staff rooms and equipment, the apparatus comprising:
means for segregating appointments into distinct appointment groups based on existing appointment types;
means for collecting timing data for the first subject organization for each appointment group;
means for describing existing scheduling practices in the form of a schedule template which utilizes the distinct appointment groups created; and
means for using Monte Carlo simulation and the timing data collected for each of the distinct appointment groups to predict customer wait times for current scheduling policies and practices.

53. An apparatus for creating earlier and more reliable start times in a working period for staff members of an organization having one or more staff members who use a schedule of appointments for its customers, and a service pipeline involving more than one process step, such that at least one staff member must wait on preparatory steps before seeing a customer, the apparatus comprising:
means for minimizing the duration of the preparatory steps during an initial portion of the working period by identifying those appointments which require shorter preparatory times and scheduling the appointments with shorter preparatory times in the initial portion of the working period.

54. An apparatus for creating earlier and more reliable finish times in a working period for staff members of an organization having one or more staff members who use a schedule of appointments for its customers, and a service pipeline involving more than one process step, such that at least one staff member must wait on preparatory steps before seeing a customer, the apparatus comprising:
means for minimizing the duration of the preparatory steps during a final portion of the working period by identifying those appointments which require shorter preparatory times and scheduling the appointments with shorter preparatory times in the final portion of the working period.

55. An apparatus for increasing throughput and controlling appointment wait times for customers of a professional office having staff members and key resources subject to policies of the professional office, the professional office having one or more staff members who use a management system that produces customer and schedule data that allows its staff members to manage the operation of the professional office based on prospective appointments for its customers, the prospective appointments being input into the management system by the one or more of its staff members, the key resources including staff rooms and professional equipment, the apparatus comprising:
means for measuring the lengths of time required from staff members and key resources by a statistically significant sample of appointments;
means for developing one or more schedule templates that designate how appointments should be scheduled, using a single appointment type for each staff member being scheduled;
means for testing and refining the one or more schedule templates using Monte Carlo simulation and the measured lengths of time;
means for selecting one of the one or more schedule templates for use in scheduling appointments for the professional office; and
means for scheduling appointments according to the selected schedule template.
